(19) United States
(12) Patent Application Publication
(10) Pub. No.: US 2014/0344031 A1
(43) Pub. Date: Nov. 20, 2014

(54) METHOD AND APPARATUS FOR PROVIDING REAL TIME OR NEAR REAL TIME INFORMATION FOR SOCIAL INTERACTION

(71) Applicant: SOCIALTOPIAS, INC., Denver, NC (US)

(72) Inventors: Joshua Clinton Lineberger, Denver, NC (US); Ward Benjamin Thompson, Charlotte, NC (US)

(21) Appl. No.: 14/450,779

(22) Filed: Aug. 4, 2014

Related U.S. Application Data
(63) Continuation-in-part of application No. 13/836,727, filed on Mar. 15, 2013.
(60) Provisional application No. 61/724,114, filed on Nov. 8, 2012.

(51) Int. Cl. H04L 29/08; G06Q 30/02; G06F 3/0484

(52) U.S. Cl. CPC H04L 67/10; G06F 3/04842; H04L 67/306; G06Q 30/0261; G06Q 30/0255; G06Q 30/0252; G06Q 30/0269
USPC 705/14.5; 715/733; 709/204; 705/14.58; 705/14.53

(57) ABSTRACT

Methods, apparatuses, and computer program products are described herein that are configured to enable a user or group of users to organize an event in the digital world that results in attendance in the physical world. One example embodiment may include a method for providing a user interface configured to allow selection of at least one time or time period from a plurality of times, receiving, via the user interface, user input that indicates at least one time or time period, a status, and a location of a user; and determining one or more users or one or more entities that match at least the time or time period, the status, and the location of the user, the one or more users or the one or more entities that match at least the time or time period, the status, and the location of the user are provided with access to information related to the user and the user is provided with access to information related to the one or more users or the one or more entities.

### CROSS-REFERENCE TO RELATED APPLICATIONS

The present application is a continuation in part of U.S. application Ser. No. 13/836,727, entitled “Method and Apparatus for Social Interaction”, filed on Mar. 15, 2013, which claims the benefit of U.S. Provisional Application No. 61/724,114, entitled “METHOD AND APPARATUS FOR SOCIAL INTERACTION”, filed on Nov. 8, 2012, both of which are incorporated herein in their entirety.

### TECHNOLOGICAL FIELD

Embodiments of the present invention relate generally to social media technologies and, more particularly, relate to a method, apparatus, and computer program product for using a digital social medium to increase interaction in the physical world.

### BACKGROUND

Over one billion people are members of social media and networking sites around the world. However, as more and more people become connected in the digital world via social media, fewer and fewer connections are made in the physical world. As such, people are feeling less and less connected.

One way social media websites provide the illusion of connection is by enabling a user to set a status for their current mindset or interests. This status may be shared with each friend, acquaintance or with anyone on the site and in return the user can view the status of others. However, the mere setting of a status does not result in an action or an interaction between people. Instead, these status updates or posts may result in little interaction or indeed no interaction at all. Consequently, five hundred people may know a user wants to see the latest movie, while the user sits at home without any indication that anyone else is interested in the same movie or, importantly, that anyone would like to attend that movie with the user. Additionally, a local movie theater also may not be able to ascertain that the user wants to the see the movie and thus cannot reach out to that user to offer incentives, offers and/or the like.

### BRIEF SUMMARY

In some embodiments, a method may be provided comprising providing a user interface configured to allow selection of at least one time or time period from a plurality of times, receiving, via the user interface, user input that indicates at least one time or time period, a status, and a location of a user, and determining one or more users or one or more entities that match at least the time or time period, the status, and the location of the user, wherein the one or more users or the one or more entities that match at least the time or time period, the status, and the location of the user are provided with access to information related to the user and the user is provided with access to information related to the one or more users or the one or more entities.

In some embodiments, the method may further comprise receiving user input indicating at least one interest of the user, determining one or more entities that match at least the time or time period, the status, the location, and the interest of the user, wherein the one or more entities that match the time or time period, the status, the location, and the interest of the user are provided with access to information related to the user or the user is provided with access to information related to the one or more entities.

In some embodiments, the method may further comprise facilitating the one or more entities to provide one or more offers to the user based on one of the status and location of the user. In some embodiments, the method may further comprise facilitating the one or more entities to provide one or more offers to the user based on one of the status, location, and interest of the user.

In some embodiments, the method may further comprise causing the user interface to be adapted to display one or more users or one or more entities that match at least one of the time or time period, the status, and the location of the user. In some embodiments, the method may further comprise wherein the user interface is a map, and the map is adapted to display the one or more users or one or more entities that match at least one of the time or timer period, the status, and the location of the user. In some embodiments, the method may further comprise wherein the user interface comprises at least a list, the list adapted to display the one or more users or one or more entities that match at least one of the time or timer period, the status, and the location of the user, wherein an order of display of the one or more users or one or more entities is determined by relevance and a user credibility rating of the user.

In some embodiments, the method may further comprise determining that the user and at least one or more users have a matching time or time period, status and location, and facilitating formation of a group, the group comprised of the user and the one or more users. In some embodiments, the method may further comprise determining one or more entities that match the status and location of the group, and enabling the one or more entities to interact with the group. In some embodiments, the user is a group of users. In some embodiments, a default time or time period is a current time, and one or more users or one or more entities that match at least the status and the location of the user at the current time is determined. In some embodiments, the status, location, or interest comprises additional text.

In some embodiments, a method may be provided comprising providing input indicating at least one time or time period, a status, a location, and an interest, and receiving data, configured for display on a news feed, indicative of one or more users or one or more entities that match the time or time period, the status and the location, an order of display of the one or more users or one or more entities determined by relevance to the interest.

In some embodiments, the method may further comprise receiving one or more offers from the one or more entities based on one of the status, location, and interest of the user. In some embodiments, the method may further comprise providing an indication of an acceptance of the offer. In some embodiments, the method may further comprise selecting one or more users or one or more entities with which to communicate, and communicating with one or more users or one or more entities that match the time or time period, the status, the location, and the interest of the user. In some embodiments, the method may further comprise in an instance in which the status or the interest is associated with an event, following the event or providing information indicating an intent to attend the event.

In some embodiments, a default time or time period is a current time, and data indicative of one or more users or one or more entities that match at least the status and the location of the user at the current time is received.

In some embodiments, a method may be provided comprising providing at least a time or time period and status information indicative of an event, receiving data indicative of one or more users that match the status and the time or time period, establishing a communication directed to the one or more users, wherein the communication comprises information related to the event.

In some embodiments, the method may further comprise generating an offer related to the event, and communicating the communication to the one or more users, the communication comprising the offer. In some embodiments, the method may further comprise selecting one or more users that match the status, wherein the communication is communicated to the selected one or more users. In some embodiments, the user is a single user or a group of users. In some embodiments, a default time or time period is a current time, and data indicative of one or more users or one or more entities that match at least the status and the location of the user at the current time is received.

In some embodiments, an apparatus may be provided comprising at least one processor and at least one memory including computer program code, the at least one memory and the computer program code configured to, with the processor, cause the apparatus to at least provide a user interface configured to allow selection of at least one time or time period from a plurality of times, receive, via the user interface, user input that indicates at least one time or time period, a status, and a location of a user, and determine one or more users or one or more entities that match at least the time or time period, the status, and the location of the user, wherein the one or more users or the one or more entities that match at least the time or time period, the status, and the location of the user are provided with access to information related to the user and the user is provided with access to information related to the one or more users or the one or more entities.

In some embodiments, the at least one memory and the computer program code are further configured to, with the processor, cause the apparatus to receive user input indicating at least one interest of the user, determine one or more entities that match at least the time or time period, the status, the location, and the interest of the user, wherein the one or more entities that match the time or time period, the status, the location, and the interest of the user are provided with access to information related to the user or the user is provided with access to information related to the one or more entities.

In some embodiments, the at least one memory and the computer program code are further configured to, with the processor, cause the apparatus to facilitate the one or more entities to provide one or more offers to the user based on one of the status and location of the user. In some embodiments, the at least one memory and the computer program code are further configured to, with the processor, cause the apparatus to facilitate the one or more entities to provide one or more offers to the user based on one of the status, location, and interest of the user.

In some embodiments, the at least one memory and the computer program code are further configured to, with the processor, cause the apparatus to cause the user interface to be adapted to display one or more users or one or more entities that match at least one of the time or time period, the status, and the location of the user. In some embodiments, the user interface is a map, and the map is adapted to display the one or more users or one or more entities that match at least one of the time or timer period, the status, and the location of the user. In some embodiments, the user interface comprises at least a list, the list adapted to display the one or more users or one or more entities that match at least one of the time or timer period, the status, and the location of the user, wherein an order of display of the one or more users or one or more entities is determined by relevance and a user credibility rating of the user.

In some embodiments, the at least one memory and the computer program code are further configured to, with the processor, cause the apparatus to determine that the user and at least one or more users have a matching time or time period, status and location, and facilitate formation of a group, the group comprised of the user and the one or more users.

In some embodiments, the at least one memory and the computer program code are further configured to, with the processor, cause the apparatus to determine one or more entities that match the status and location of the group, and enable the one or more entities to interact with the group.

In some embodiments, the user is a group of users. In some embodiments, a default time or time period is a current time, and one or more users or one or more entities that match at least the status and the location of the user at the current time is determined. In some embodiments, the status, location, or interest comprises additional text.

In some embodiments, an apparatus may be provided comprising at least one processor and at least one memory including computer program code, the at least one memory and the computer program code configured to, with the processor, cause the apparatus to at least provide input indicating at least one time or time period, a status, a location, and an interest, and receive data, configured for display on a news feed, indicative of one or more users or one or more entities that match the time or time period, the status and the location, an order of display of the one or more users or one or more entities determined by relevance to the interest.

In some embodiments, the at least one memory and the computer program code are further configured to, with the processor, cause the apparatus to receive one or more offers from the one or more entities based on one of the status, location, and interest of the user. In some embodiments, the at least one memory and the computer program code are further configured to, with the processor, cause the apparatus to provide an indication of an acceptance of the offer.

In some embodiments, the at least one memory and the computer program code are further configured to, with the processor, cause the apparatus to select one or more users or one or more entities with which to communicate, and communicate with one or more users or one or more entities that match the time or time period, the status, the location, and the interest of the user. In some embodiments, the at least one memory and the computer program code are further configured to, with the processor, cause the apparatus to in an instance in which the status or the interest is associated with an event, follow the event or providing information indicating an intent to attend the event.

In some embodiments, a default time or time period is a current time, and data indicative of one or more users or one or more entities that match at least the status and the location of the user at the current time is received.

In some embodiments, an apparatus may be provided comprising at least one processor and at least one memory including computer program code, the at least one memory and the computer program code configured to, with the processor, cause the apparatus to at least provide at least a time or time period and status information indicative of an event, receive data indicative of one or more users that match the status and the time or time period, establish a communication directed to the one or more users, wherein the communication comprises information related to the event.

In some embodiments, the at least one memory and the computer program code are further configured to, with the processor, cause the apparatus to generate an offer related to the event, and communicate the communication to the one or more users, the communication comprising the offer In some embodiments, the at least one memory and the computer program code are further configured to, with the processor, cause the apparatus to select one or more users that match the status, wherein the communication is communicated to the selected one or more users.

In some embodiments, the user is a single user or a group of users. In some embodiments, a default time or time period is a current time, and data indicative of one or more users or one or more entities that match at least the status and the location of the user at the current time is received.

In some embodiments, a computer program product may be provided comprising at least one computer-readable storage medium having computer-executable program code instructions stored therein, the computer-executable program code instructions comprising program code instructions for providing a user interface configured to allow selection of at least one time or time period from a plurality of times, receiving, via the user interface, user input that indicates at least one time or time period, a status, and a location of a user, and determining one or more users or one or more entities that match at least the time or time period, the status, and the location of the user, wherein the one or more users or the one or more entities that match at least the time or time period, the status, and the location of the user are provided with access to information related to the user and the user is provided with access to information related to the one or more users or the one or more entities.

In some embodiments, the computer-executable program code instructions further comprise program code instructions for receiving user input indicating at least one interest of the user, determining one or more entities that match at least the time or time period, the status, the location, and the interest of the user, wherein the one or more entities that match the time or time period, the status, the location, and the interest of the user are provided with access to information related to the user or the user is provided with access to information related to the one or more entities.

In some embodiments, the computer-executable program code instructions further comprise program code instructions for facilitating the one or more entities to provide one or more offers to the user based on one of the status and location of the user. In some embodiments, the computer-executable program code instructions further comprise program code instructions for facilitating the one or more entities to provide one or more offers to the user based on one of the status, location, and interest of the user.

In some embodiments, the computer-executable program code instructions further comprise program code instructions for causing the user interface to be adapted to display one or more users or one or more entities that match at least one of the time or time period, the status, and the location of the user. In some embodiments, the user interface is a map, and the map is adapted to display the one or more users or one or more entities that match at least one of the time or timer period, the status, and the location of the user. In some embodiments, the user interface comprises at least a list, the list adapted to display the one or more users or one or more entities that match at least one of the time or timer period, the status, and the location of the user, wherein an order of display of the one or more users or one or more entities is determined by relevance and a user credibility rating of the user.

In some embodiments, the computer-executable program code instructions further comprise program code instructions for determining that the user and at least one or more users have a matching time or time period, status and location, and facilitating formation of a group, the group comprised of the user and the one or more users. In some embodiments, the computer-executable program code instructions further comprise program code instructions for determining one or more entities that match the status and location of the group, and enabling the one or more entities to interact with the group.

In some embodiments, the user is a group of users. In some embodiments, a default time or time period is a current time, and one or more users or one or more entities that match at least the status and the location of the user at the current time is determined. In some embodiments, the status, location, or interest comprises additional text.

In some embodiments, a computer program product may be provided comprising at least one computer-readable storage medium having computer-executable program code instructions stored therein, the computer-executable program code instructions comprising program code instructions for providing input indicating at least one time or time period, a status, a location, and an interest, and receiving data, configured for display on a news feed, indicative of one or more users or one or more entities that match the time or time period, the status and the location, an order of display of the one or more users or one or more entities determined by relevance to the interest.

In some embodiments, the computer-executable program code instructions further comprise program code instructions for receiving one or more offers from the one or more entities based on one of the status, location, and interest of the user. In some embodiments, the computer-executable program code instructions further comprise program code instructions for providing an indication of an acceptance of the offer.

In some embodiments, the computer-executable program code instructions further comprise program code instructions for selecting one or more users or one or more entities with which to communicate, and communicating with one or more users or one or more entities that match the time or time period, the status, the location, and the interest of the user.

In some embodiments, the computer-executable program code instructions further comprise program code instructions for in an instance in which the status or the interest is associated with an event, following the event or providing information indicating an intent to attend the event.

In some embodiments, a default time or time period is a current time, and data indicative of one or more users or one or more entities that match at least the status and the location of the user at the current time is received.

In some embodiments, a computer program product may be provided comprising at least one computer-readable storage medium having computer-executable program code instructions stored therein, the computer-executable program code instructions comprising program code instructions for providing at least a time or time period and status information indicative of an event, receiving data indicative of one or more users that match the status and the time or time period, establishing a communication directed to the one or more users, wherein the communication comprises information related to the event.

In some embodiments, the computer-executable program code instructions further comprise program code instructions for generating an offer related to the event, and communicating the communication to the one or more users, the communication comprising the offer.

In some embodiments, the computer-executable program code instructions further comprise program code instructions for selecting one or more users that match the status, wherein the communication is communicated to the selected one or more users.

In some embodiments, the user is a single user or a group of users. In some embodiments, a default time or time period is a current time, and data indicative of one or more users or one or more entities that match at least the status and the location of the user at the current time is received.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a schematic representation of a social media environment that may benefit from some example embodiments of the present invention;

FIGS. 2-4 illustrate example flowcharts that may be performed by a social status interaction system in accordance with some example embodiments of the present invention;

FIG. 5 illustrates a block diagram of an apparatus that embodies a social status interaction system in accordance with some example embodiments of the present invention;

FIGS. 6-13 illustrate example flowcharts that may be performed during an interaction with a social status interaction system in accordance with some example embodiments of the present invention;

FIG. 14 shows an example graphical user interface display that may be presented by various components of systems, in accordance with some embodiments of the present invention;

FIGS. 15A and 15B show example graphical user interface display that may be presented by various components of systems, in accordance with some embodiments of the present invention;

FIG. 16 illustrates an example flowchart that may be performed by a social in accordance with some example embodiments of the present invention;

FIG. 17 illustrates an example flowchart that may be performed in accordance with some example embodiments of the present invention; and

FIG. 18 illustrates an example flowchart that may be performed in accordance with some example embodiments of the present invention;

FIG. 19-24 show data flow diagrams for performing various exemplary use cases, performed in accordance with some embodiments of the present invention.

### DETAILED DESCRIPTION

Example embodiments will now be described more fully hereinafter with reference to the accompanying drawings, in which some, but not all, embodiments are shown. Indeed, the embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

In some examples of current social networking applications and, as mentioned above, users are limited to posting a status that does not result in an action. For example, at the end of the work day a user may post: “I am interested in going to a sports bar after work.” While this message may be read by a plurality of users, the current examples of social networking applications generally fail to take any steps to encourage other users to attend the sports bar, notify the sports bars in the area of the user's interest and/or provide any encouragement for interaction in the physical world. Furthermore, current social networking application do not give a user or entity the ability to set a status, an indication of an interest, or in the case of an entity, an activity in the future by use of, for example, a calendar that is accessible as a form of social news feed. Indeed, current social networking sites fail to enable an entity to have visibility into user interest, demand and/or the like

Therefore and according to some example embodiments, a method, apparatus and computer program product, as described herein, is configured to receive an interest from a user and, as a result, place similarly interested users and corresponding entities (e.g., sports bars in the area) on notice of that interest. For example, users may select a current state (e.g., status) that provides an indication of the current status of the user. These states include, but are not limited to active, transporting and/or activated. These states are updated as a user selects a particular entity to visit (e.g., selects a sports bar from the list of sports bars in a metropolitan area), travels to that entity and then physically visits that entity. The states and an accompanying user credibility score, in some examples, are configured to funnel users into selecting a location in the physical world based on a shared interest and then to encourage the user to actually arrive or otherwise activate at the location in the physical world.

Alternatively or additionally and according to some example embodiments, a method, apparatus and computer program product, as described herein, may be configured to provide real time or near real time news feed information to users (as described herein a user may be a single user, multiple users, a group of users operating together as a group or the like) or entities. In some examples, the news feed may provide information to users or entities based on the relevance to the particular user or entity. As is further described herein, the relevance score may be driven based on a combination of state, and location. However, in accordance with the descriptions herein, the relevance score may include state, interest, focus, location, time, historical data, profile data, friend data, social networking data, or the like.

In one example embodiment, a user may set a current status by selecting a pre-programmed state, such as for example one of active, roaming, or exploring. The user may then optionally select an interest or focus, from for example a drop down menu, a tag cloud engine, a text box, a free text entry or the like. The tag cloud engine may be a visual representation of one or more interests, focuses, or the like. In some embodiments, additionally or alternatively, the user may be provided with a free form text bar which links user entered text to various pre-programmed tags that are representative of one or more interests or focuses.

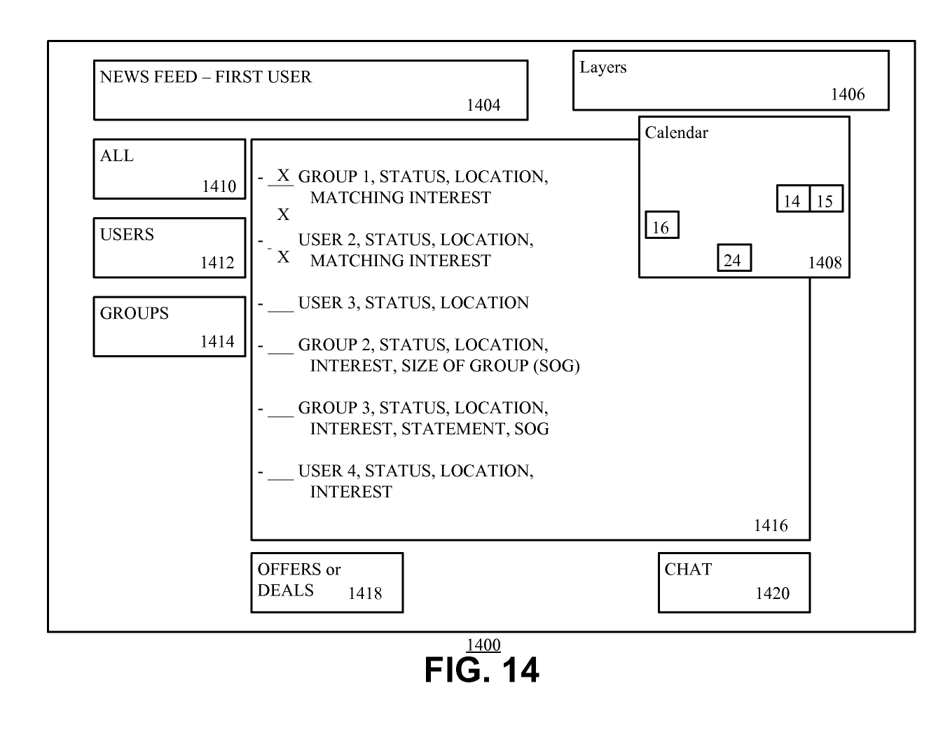

Interests or focuses may include, but are not limited to a particular interest in sporting events, bars, indoor activities, outdoor activities, live music, dance party, karaoke, sports bars, nightclubs or the like. The user may also type text, such as, for example, “Let's go Panthers” to be added to a particular focus or interest so as to indicate a particular preference (e.g., sports bars where Panther's fans may be present). The system may be configured to post the state, interest, text or the like to, for example, a news feed according to privacy settings (see e.g., FIG. 14).

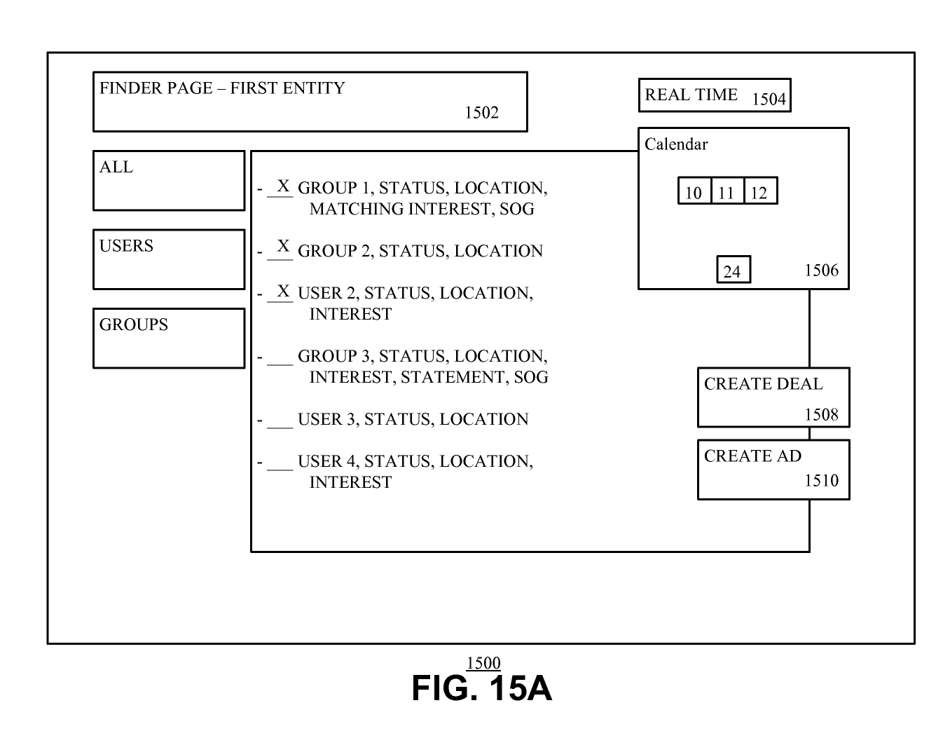

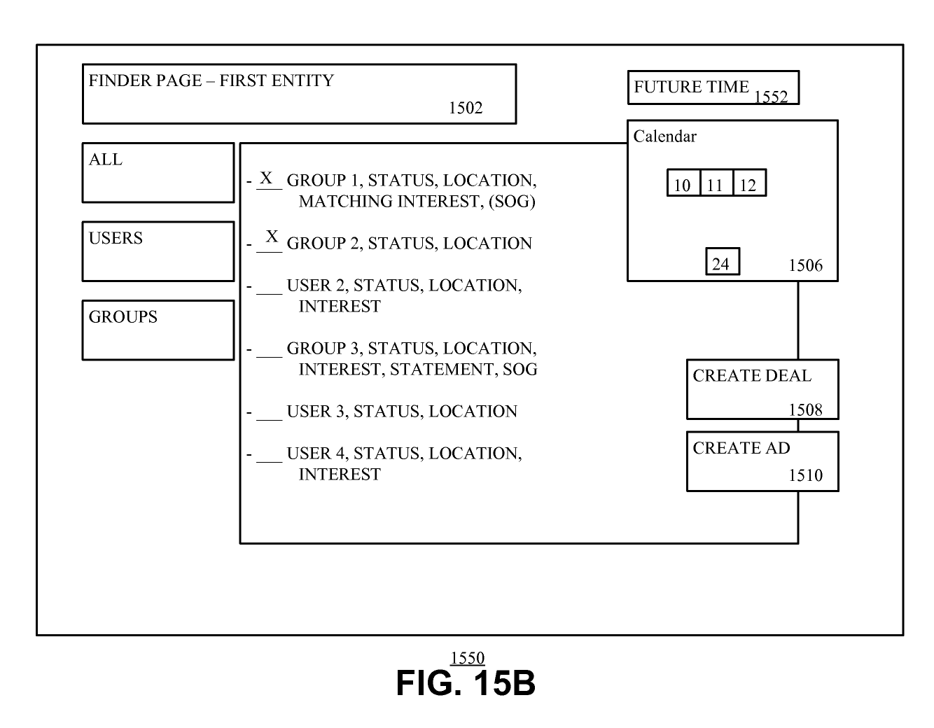

In some examples, the system may then update a user's news feed to show other users who are active with an interest in sports bars (e.g., other users who share a common interest with the current user). Alternatively or additionally, the system may provide all entities in the area the ability to see a current user status. Entities that match or otherwise share the interest or focus of a user (e.g., sports bars in the current example) may then see the “interested” users on their “finder page” (e.g., a user finding news feed for entities). In some examples, the entities may target advertising or offers to those interested users. Exemplary finder pages are shown, for example, in FIGS. 15A and 15B. In some embodiments, the matching process may display those users who post more specific interests or states (e.g., “interest”—‘sports bars’—), closer to the top of users, groups, or entities' lists who match the interest.

In some examples, a user or entity may set a future status. In such examples, users and/or entities may use a calendaring and/or scheduling function, such as a news feed calendar, to set such a status and/or view the status, interest or activity of other entities or users on future days.

In some embodiments, a news feed may provide posts along with or separately from the news feed calendar. The news feed may contain items such as user states, user interests, photos, posts, check-ins, activations, locations, media, links or the like. In particular, the news feed may provide current or future lists of users, groups of users and/or entities with a matching interest and/or focus. In some examples, the systems and methods described herein may rank or otherwise include items in the news feed according to the time at which the status is set, the level of connection between the user, previous connections, similar locations, being members of similar groups or the like.

An entity “user finder page” news feed has similar functionality as the news feed described above, however an entity news feed is configured to enable the entity to send a deal or offer to a user with an interest or focus which matches the business tags and or activity users who have set a status that they are active in the network, based on a relevance score or the like. In some embodiments, the status may be related to or otherwise be bounded by a location (e.g., a news feed may only show users with a social state (active, roaming, exploring), matching users, and groups of users or entities, within a particular geographic region). In some embodiments, offers may be provided to the user based on a current or future state, interest, and/or focus. A deal may be a coupon type provision (e.g., 2 for 1, 50% off or the like). In some examples, the deals or offers may be contemporaneous setting or selecting of a status, interest or focus, whereas in other examples the deals or offers may be in the future. Irrespective of the provision of a deal or offer, the entity may be enabled to communicate (e.g., in real time or semi-real time) with one or more users or groups of users.

As is described throughout, the news feed is configured to show other users, groups of users or entities. The news feed may be configured to determine what content to show based on relevance or other ranking method. As is described herein, relevance may include a match in status, may include a proximity score, may include an interest or focus or the like. In some embodiments, relevance may include a user credibility score, such that a higher user credibility score enables a user, a group of users, or an entity to be provided higher in the ranking In some examples, the news feed may include users, groups of users or entities that match a status and are proximate to a geographical area. In other examples, all (or, in some embodiments, a portion of) users proximate to a geographical area are displayed, but they are ranked according to one or more of a match in status, match in interest or focus, a similar interest score, a user credibility score or rating, or the like. In some embodiments, the use of user may include a group of users. In other words, in some embodiments, a group of users may be afforded any of, including, in some embodiments, all, of the features, benefits, characteristics or the like of a single user. For example, in some embodiments, the news feed may use the social status system to enable people who have the same social mindset to easily find each other, communicate, and take action to get together and be social in person.

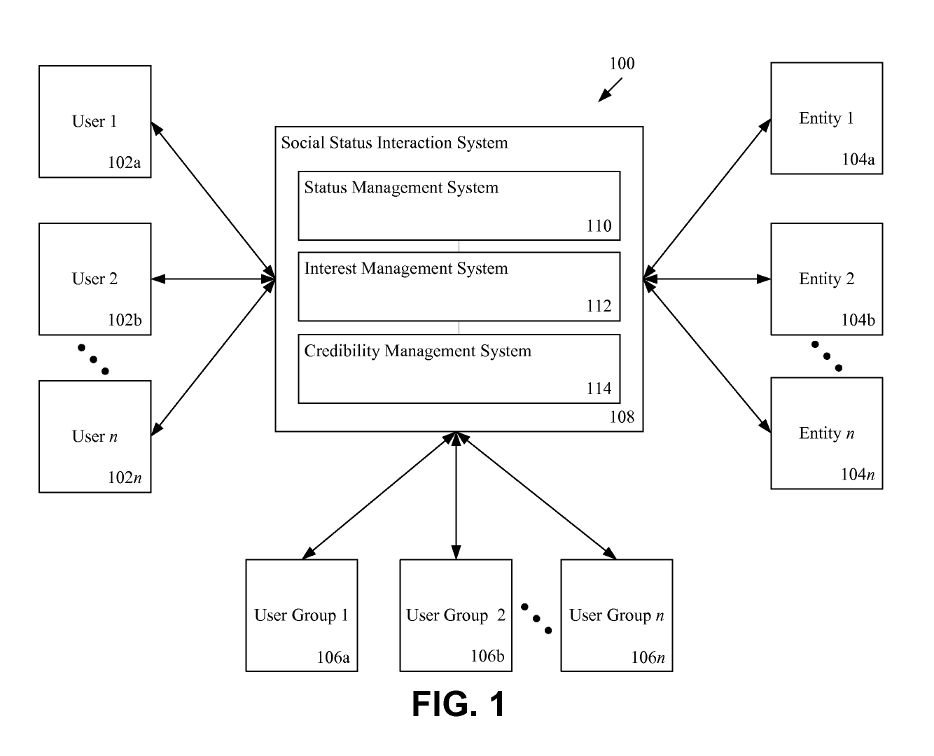

FIG. 1 is an example block diagram of example components of an example social media environment 100. In some example embodiments, the social media environment 100 comprises one or more users 102a-102n, one or more entities (e.g., establishments, businesses, destinations, entertainers, promoters, etc.) 104a-104n, one or more user groups (e.g., event entourages) 106a-106n, and/or a social status interaction system 108. The social status interaction system 108 may take the form of, for example, a code module, a component, circuitry and/or the like. The components of the example social media environment 100 are configured to provide various logic (e.g., code, instructions, functions, routines and/or the like) and/or services related to the social status interaction system 108 and its components.

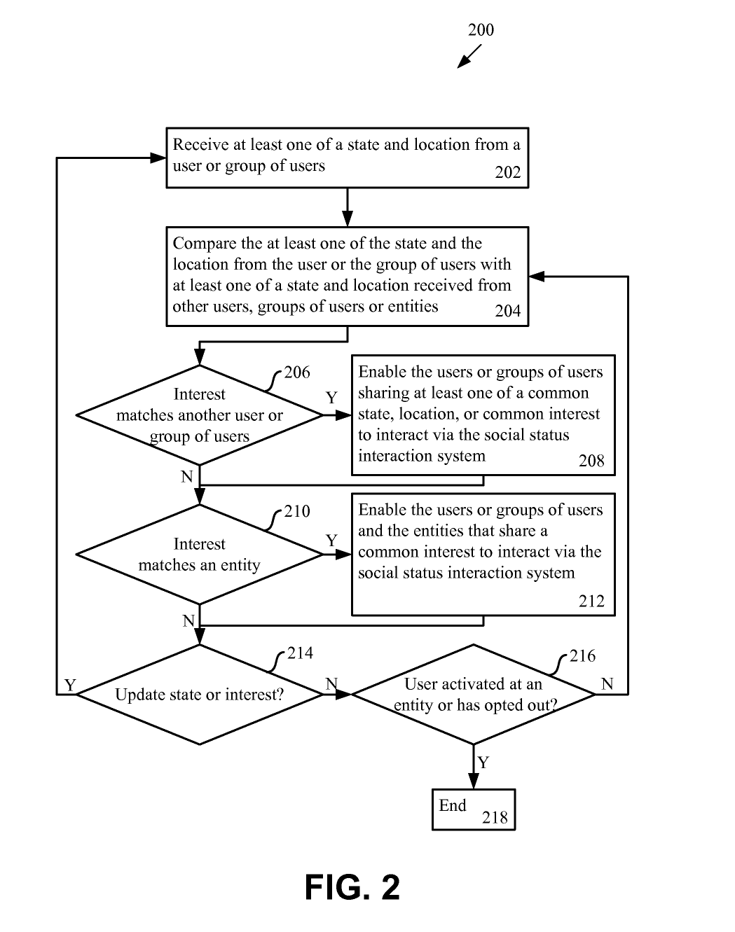

The social status interaction system 108 may further comprise a status management system 110, an interest management system 112 and/or a credibility management system 114. The status management system 110 is configured to receive and/or otherwise determine a current state of one or more users 102a-102n and one or more user groups 106a-106n. Additionally or alternatively, the status management system 110 may be configured to receive and/or otherwise determine a future state of one or more users 102a-102n and one or more user groups 106a-106n using, for example, a calendar functionality or any functionality for displaying and/or managing at least one future time. In some examples, the status management system 110 may be further configured to share status information between the one or more users 102a-102n, one or more entities 104a-104n and/or one or more user groups 106a-106n. For example, the status management system 110 may share the current and/or future state of user 1 102a with user 2 102b and/or with entity 1 104a. Sharing of states is further described with reference to FIG. 2.

In some embodiments, entities may be able set status via the calendar functionality for the current time or, in some examples for a future time. In one example embodiment, the entity may set a status by accessing the calendar, identifying a day and then entering a particular status and/or and interest/focus. Entities may also create events. Once entered by the entity, events may be accessible or otherwise viewable by the users or by one or more groups of users. In some embodiments, once entered by the entity, a user or group of users may then access his/her/their calendar for the purpose of identifying the particular activity or status by the entity from a list of entities. In other examples, the user or group of users may be presented with a listing of entities that match the user's or group's status, location, and/or interest/focus for the current time or a future time. Such a list can also be provided via a search function, such as a search for particular interests/focus or events.

In some examples, users may be able set status via the calendar functionality for the current time or, additionally or alternatively, for a future time. In one example embodiment, the calendar functionality may be accessible via a news feed page. By use of the calendar functionality, the user is able to designate day he/she is planning on being active and may list particular interests/focuses for a specific period of time (e.g., a day, a period of hours, a period of days or the like). Users may also follow (e.g., elect to receive updates or news from an event, person or groups of people for a particular time frame from a news feed, elect to receive updates related to an event or the like) or attend (receive updates, commit to attend and/or be able to post to a news feed for an event) for a current or future event. Indeed, social information for a particular date will be made available to a user upon request.

In some example embodiments, the status management system 110 may define multiple states for the one or more users 102a-102n and the one or more user groups 106a-106n. These states include, but are not limited to pending (e.g., waiting for an indication of a current state from the one or more users 102a-102n and the one or more user groups 106a-106n), active (e.g., a user is interested in being social and is looking for opportunities), exploring (e.g., a user is generally interested in being socially active with destinations or locations which the user has not yet “activated” at), and roaming (e.g., user is interested in being socially active but does not want to join with a group and/or entourage). Also, user may select state of Transporting (e.g., user is en route to a location or in transit to a general area), committed (e.g., a user has committed to a particular location), activated (e.g., a user has arrived and has taken some affirmative step to indicate arrival at a physical location), “building” (e.g., user is forming a group to partake in some form of social activity), and/or “inactive” (e.g., user is opting out of social activity at the current time). In some examples, the one or more users 102a-102n and the one or more user groups 106a-106n may be set to pending at a certain time in the day to encourage the user to update their current state (e.g., each user is set to pending at 5 pm). The status management system 110 may then be configured to receive state updates from a user or, in some example embodiments, detect state changes based on an action by the user, such as, but not limited to, creating of a group, the ordering of a taxi, payment of an entry fee (e.g., cover, ticket or the like), global positioning system (GPS) indication, quick response (QR) code, other purchases, posting a status, a calendar entry and/or the like.

Alternatively or additionally, the status management system 110 may define multiple states for the one or more entities 104a-104n. In some example embodiments, states and/or “tags” for the one or more entities 104a-104n may be selected, defined and/or otherwise determined at a time in which the one or more entities 104a-104n sign up or create their pages (e.g., destination page). For example, a restaurant may select or otherwise set its state as “brunch” from 9 am-2 pm on Friday-Sunday. Other states may be selected by the one or more entities 104a-104n to reflect the desired business position of the entity. For example, a restaurant may set its status to “happy hour” or “specials” to highlight attractive discounts to the one or more users 102a-102n and the one or more user groups 106a-106. In some examples, the state change may also cause a change in the destination page for that entity. For example, a restaurant that has set “brunch” as its state from 9 am-2 pm may have its state automatically changed at 9 am on Friday and, as such, may have its destination page change to include a brunch menu or other information related to its current state. Further at the time of the state change, the restaurant may then be able to see or otherwise have access to the one or more users 102a-102n and the one or more user groups 106a-106n that have set their interest to match the state of entity, for example, “brunch.” Additional entity interests, focuses and/or tags may include but are not limited to live music, dance party, sporting event, outdoor activities, indoor activities, brunch, happy hour, sports bar, diner, fine dining, casual dining, each of which, in some embodiments, may be included in the tag cloud engine. In some embodiments, a tag cloud engine may contain a plurality of states, interests, focuses, tags or the like that may be displayed visually, contained in a list, accessible via a text box or the like. In some embodiments, an entity may be able to see or otherwise have access to the one or more users, and the one or more user groups, that have set their interest to match a tag of the entity, or matching the entity type. For example, a user who has set an interest in Mexican dining will be viewable to entities identified by, for example, with an entity tag for Mexican cuisine. In some embodiments, additionally or alternatively, a user may set a more detailed interest for Mexican restaurants, and karaoke. The “finder page” news feed function may now display this user at the top of such news feed as highly relevant for entities identified by, for example, as Mexican restaurants that have used the calendar function to or have otherwise set a focus for karaoke on this particular date. The end result here, in some examples, is that entities that have one or more particular tags (e.g., Mexican restaurant, Karaoke), can see in real time or near real time, users and user groups that have a highly relevant interest in their entity.

Additionally or alternatively, entities may also view users and groups of users who have a social state “active”, “exploring”, “roaming”, “building”, but do not have a selected interest that matches their entity. Such users or groups of users may simply appear lower on the entity's “user finder page” feed, as the users may be identified as less relevant than those with a direct matching interest.

In some example embodiments, the interest management system 112 is configured to track the one or more interests that are provided by the one or more users 102a-102n and the one or more user groups 106a-106n. The interest management system 112 is further configured to determine the one or more entities 104a-104n that match those one or more interests or otherwise have been identified as matching those interests (e.g., identify an entity that is a sports bar). As will be described with further reference in at least FIG. 2, the interest management system 112 is configured to pair or otherwise provide notice of a shared interest between the one or more users 102a-102n, one or more entities 104a-104n and/or one or more user groups 106a-106n to further encourage the one or more users 102a-102n, one or more entities 104a-104n and/or one or more user groups 106a-106n to have an interaction in the physical world. In some embodiments, the interest management system 112 is configured to provide or enable entities to find, for example via a “user finder page”, one or more of currently socially active users or groups matching interest/focus and/or future users or groups, that are interested in being socially active and share a common interest/focus with, for example, an entity tag. In some embodiments, the status management system 110 may provide entities with the ability to find users who have a social state that corresponds to being socially active (“active”, “exploring”, “roaming”), and groups created with a focus for social activity in the geographic region of the entity. Such groups and users who do not have a defined interest that matches may then be less relevant to the entity, and thus appear lower on the “user finder page” than users who have a matching interest/focus tag with the entity. The interest management system 112 may be further configured to enable user, groups, or entities to view, via news feed, any or all above information pertaining to users and/or status of entities (e.g., live music, dance party, outdoor activities, sports event, or the like).

Alternatively or additionally and in some example embodiments, the interest management system 112 may be further configured to enable the one or more users 102a-102n, the one or more entities 104a-104n and/or the one or more user groups 106a-106n to follow the social activity of one or more entities. In some examples, the one or more users 102a-102n, the one or more entities 104a-104n and/or the one or more user groups 106a-106n may receive updates, receive state changes, view information, communicate with and/or the like from those of the one or more users 102a-102n, the one or more entities 104a-104n and/or the one or more user groups 106a-106n that they are following, they are interested in, that match preferences or the like. For example, in an instance in which a restaurant sets its state, or posts to its “followers” for “brunch,” a user may see this state change/post on a news feed, information feed or the like. In other examples, a communication interface (e.g., instant message, email, messaging, phone or other communication medium) may be established between the one or more users 102a-102n, the one or more entities 104a-104n and/or the one or more user groups 106a-106n that match a location, interest, focus and/or the like.

In some embodiments, the interest management system 112 may be further configured to enable a user to connect with an event in order to follow the event, receive updates about the event or the like. For example, once a user or group of users follow an event, the interest management system 122 may then cause posts related to the event to be added to news feed and/a calendar.

In some example embodiments, a connection may not be a part of the status system, but instead may be used to update or inform the users of particular events. As such, a connection may be configured to be enabled when a user, group, or entity follows an entity, and/or adds a user, group of users and/or entity to the user's news feed (e.g. “my scene”).

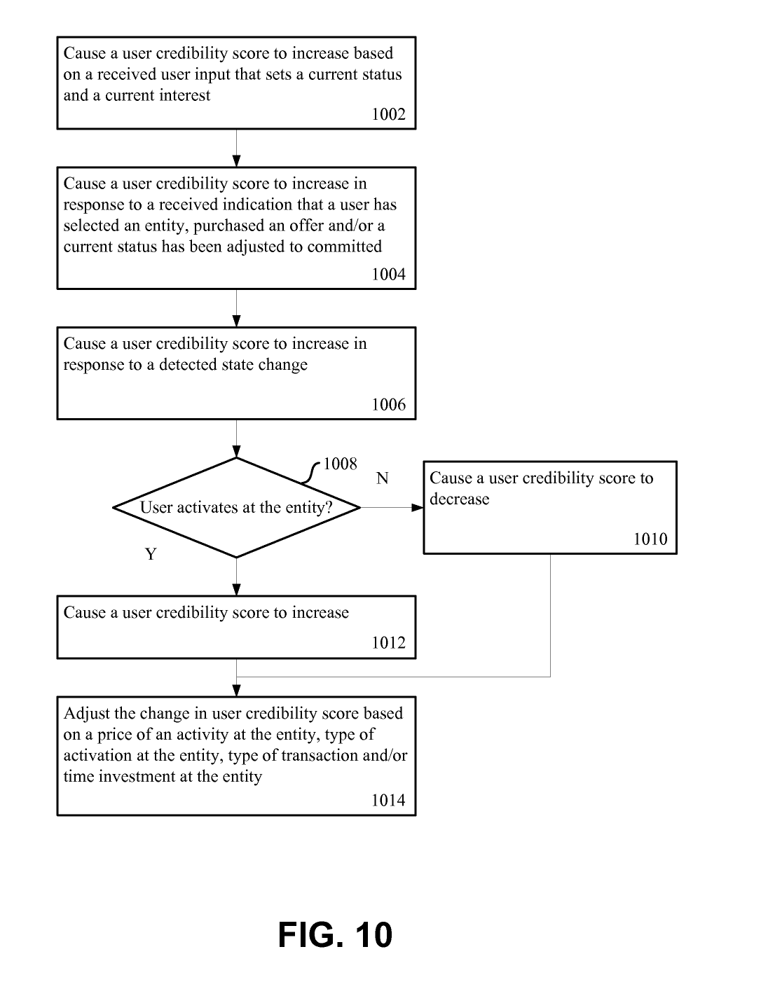

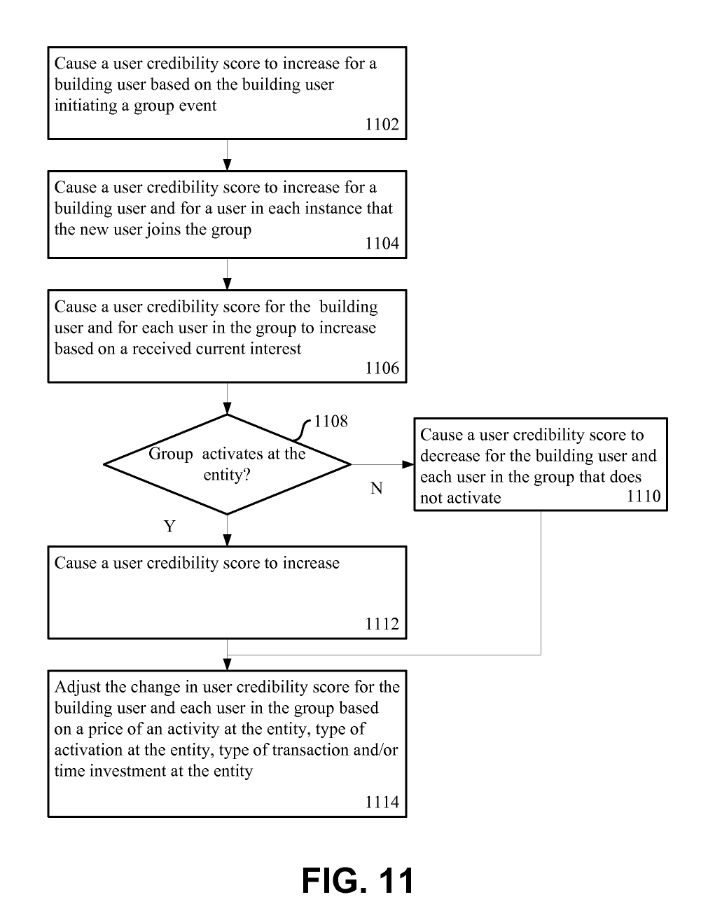

In some example embodiments, the credibility management system 114 is configured to assign a user credibility score, credits or other social capital based on the behavior of the one or more users 102a-102n, one or more entities 104a-104n and/or one or more user groups 106a-106n. For example, the more a user participates with the social media environment 100, the more points or credits will be awarded. Importantly and in some examples, the greatest number of points will be awarded when a user activates in a physical location and/or otherwise verifies an interaction in the physical world. Points may be subtracted in instances in which a user does not participate or does not follow through after being “committed”, to a particular location. As will be further described herein, the user credibility score may also be used to provide offers, rank users or entities, provide social capital among friends and/or the like. The credibility management system 114 is further described with reference to FIGS. 10 and 11.

FIG. 2 illustrates an example flowchart that may be performed by the social status interaction system 108 in accordance with some example embodiments of the present invention. In some examples, the one or more users 102a-102n, one or more entities 104a-104n and/or one or more user groups 106a-106n may access the social status interaction system 108 and select a geographical area that they are interested in participating in or where they provide services. The geographical area may be a metropolitan area, a neighborhood and/or the like. In some cases, the geographical area may be a country, state, county, zip code or other bounded spatial area. Alternatively or additionally, a user may set the geographical area by drawing a region of interest (e.g., crop box) via a map in a user interface in some examples.

As is shown in block 202, the status management system 110, the interest management system 112 or the like may receive at least one of a state and location, or in some embodiments, a state, location, and/or an interest from a user or group of users (e.g., the one or more users 102a-102n and the one or more user groups 106a-106n) for the selected location or region. For example, a user may set a state to active and may set an interest to sports bars, and a location to the south end, in a or proximate to a particular city, region, county or other geographically defined area. In an instance in which a state, location, and/or interest has been received and in some example embodiments, a user interface and/or user experience may be adapted for the user. For example, a map may be displayed that provides locations that correspond to the particular interest; an information news feed may display other users with a similar interest and/or the like. As is described throughout, state, location, focus, and/or interest may be optional in some embodiments.

In response to an input state and/or interest and as shown in block 204, the status management system 110, the interest management system 112 or the like may compare the at least one of the state and location or, in some embodiments, the state, location, and the interest from the user or the group of users with at least one of a state, location, and/or an interest received from other users, groups of users or entities. For example, the interest management system 112 may be configured to match users with a similar interest (e.g. watching a football game, or “Sports bars”, “football”) in a particular geographical area. At decision block 206, the status management system 110, the interest management system 112 or the like may determine whether the state and location or, in some embodiments, the state, location, and interest of the user or group of users matches another user or group of users. In an instance in which the state and location, or state, location, and interest of the user or group of users matches another user or group of users, then at block 208, the status management system 110, the interest management system 112 or the like may display the matching or otherwise relevant users at the top of other user's news feeds, as they are most relevant and have a matching state. Such display may also show users that do not have a matching state, but such users may be less relevant to the matching users, and, thus, may be demoted in the list, marked as least relevant or the like. The system may enable the users or groups of users sharing at least one of a common state, common location, or a common interest to interact via the social status interaction system 108. For example, the interest management system 112 may be configured to permit one or more users, groups, and/or entities to interact (e.g., via a chat function or the like). Alternatively or additionally, the system may allow for communication or interaction even if the users, groups of users or the like do not share at least one of a common state, common location, or a common interest.

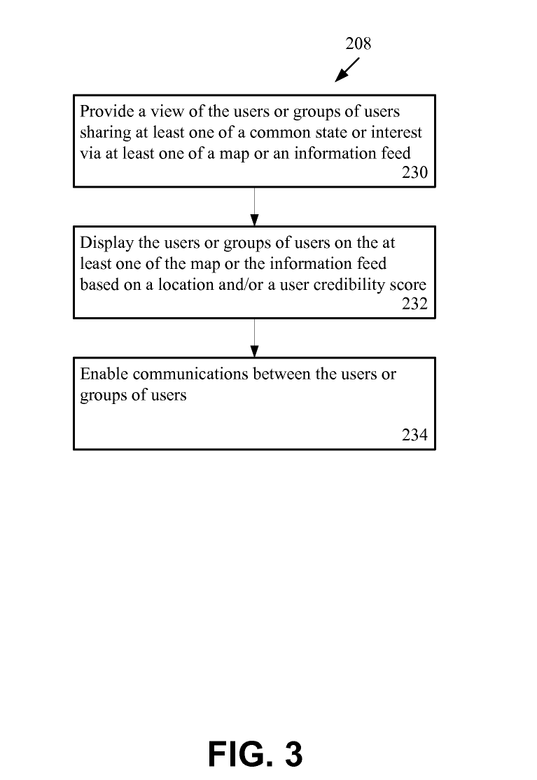

In some embodiments, the interest management system 112 may be configured to enable a group chat (e.g., chat function among more than two users, groups, and/or entities). In some embodiments, the interest management system 112 may be configured to facilitate formation of a group, such as for example, a “user group” (referred to herein in some examples as a group of users) or entourage. Users are enabled to chat and interact with other users that have any social state, regardless of the users optionally selected interest. Such an interaction is encouraged so as to funnel users sharing, for example, a socially active state of mind, and optionally a similar interest into an interaction in the physical world. Additionally, users are also enabled to chat with other users on the system whether or not they are currently socially active. Block 208 is further described with reference to FIG. 3.

In an instance in which the state and location, or state, location and interest of the user or group of users does not match another user or group of users, then at decision block 210, the status management system 110, the interest management system 112 or the like may determine whether the interest of the user or group of users matches an entity. In some examples an entity may be physical location such as a club, a stadium, a restaurant, a bar or the like, however in other examples an entity may be an entertainer, a server, a host or the like. In some example embodiments, each entity may define the specifications (e.g., an entity may set the specifications at account creation, in real-time and/or the like) of the business, event, destination or profession, and, as such, may define those user interests that the entity caters to or otherwise matches. For example, an interest in sports bars may match a restaurant that specializes in chicken wings and has numerous televisions tuned to football games, (or such a place that has set its specification as a sports bar), whereas my interest in sports bars may exclude a small bistro without a television. Such entity specifications may be accessible, for example, via a tag engine at, for example, registration, during update of the entity profile page, or the like. The various selected tags may be utilized by the system to, for example, help users to find desired entities, and help entities to identify themselves such that users may find them.

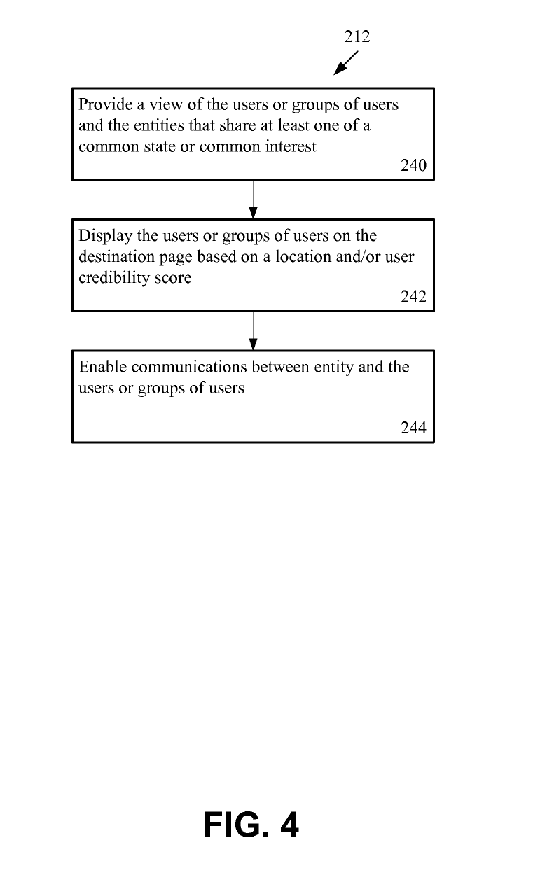

In an instance in which the interest of the user or group of users matches an entity, then at block 212, the status management system 110, the interest management system 112 or the like may enable the users or groups of users and the entities that share a common interest to interact via the social status interaction system 108. Such an interaction is further described with reference to FIG. 4. In an instance in which an interest of the user or group of users does not match an entity, then at decision block 214, the status management system 110, the interest management system 112 or the like may determine whether a user or a group of users has updated a state or an interest. For example, a user may have indicated an interest in sports bars on a day in which no major sports are being played, as such, the user may select a new interest. In an instance in which a user or a group of users has updated a state, location, or an interest, then the process returns to block 202.

In an instance in which a user or a group of users has not updated a state, location, or an interest, then at decision block 216, the status management system 110, the interest management system 112 or the like may determine whether a user has activated at an entity or has opted out. As a user transitions from an active social state (active, roaming, exploring, building, committed are all considered active social states), to, for example, activated, the state of that user may be updated and shared with other users who the user has permitted to view their social activity, and entities that share the user's interest in order to encourage interaction in the physical world. As such, once a user activates and is interacting in the physical world, the process may end at block 218. The user may still interact via the social status interaction system 108 and may use the social status interaction system 108 to attend another entity during a day by restarting the process at block 202. In some embodiments, a user may not achieve or go through each state, but may transition between states such as active and/or activation. For example, a user may walk into a sports bar and “activate” using, for example by way of a QR code, online “activation” or check in. As such, the status management system 110, the interest management system 112 or the like may be configured to post such activity to a news feed and/or to users' social page, each subject to privacy settings.

Alternatively or additionally, the user may opt out for an evening. In other cases the social status interaction system 108 may determine that updates (e.g., the process described in blocks 204, 206 and 210) should not be continued based on a time of day, amount of activity or interaction from the user, a user credibility score or the like. In an instance in which it is determined by the status management system 110, the interest management system 112 or the like that the user has not activated and/or has not been opted out then the process may return to block 206, otherwise the process ends at block 218. In some embodiments, a user may also opt out by selecting the “inactive” social state.

FIG. 3 is a flowchart that further illustrates the interactions between users or groups of users that share at least one of a common interest or a common state as shown with reference to block 208 of FIG. 2 in accordance with some example embodiments described herein. In an instance in which the state or interest of the user or group of users matches another user or group of users, then at block 230, the status management system 110, the interest management system 112 or the like may provide a view of or otherwise display via the user interface the users or groups of users sharing at least one of a common state or interest on least one of a map, information feed or the like. For example, the locations of various users that match the state and location of the users or the groups of users may be shown on a map or via an information feed. In some embodiments, the status management system 110, the interest management system 112 or the like may provide a view of or otherwise display via the user interface the users or groups of users sharing at least one of a common state and location. Furthermore, in some embodiments, one or more common interests or a common focus may factor in ordering of the users or groups of users displayed. In other words, a relevance may be determined among those users or groups of users that match the state and location, the relevance utilizing one or more other factors, such as interests of each of the user and other users or groups of users, and whether those interests match and/or how close they match. In some embodiments, other factors may be factored into a relevance determination, such as any information in a user profile, other and/or previous events followed and/or attended, size of group for groups of users. At block 232, the status management system 110, the interest management system 112 or the like may display the users or groups of users on the at least one of the map, information feed or the like based on a user credibility score. In some embodiments, the status management system 110, the interest management system 112 or the like may provide a view of or otherwise display via the user interface one or more users or groups of users with matching interests based on relevance, relevance being a function of one or more of location, state (e.g., “active”), interest, or status score. For example, the one or more users or groups of users determined more relevant may appear first in the display and other less relevant users or groups of users are displayed below in, for example, descending relevance. At block 234, the status management system 110, the interest management system 112 or the like may enable communications between the users or the groups of users. For example, a user may message another user directly who shares a particular interest. As such, users are provided the ability to collaborate and build a group to visit an entity in the physical world.

FIG. 4 is a flowchart that illustrates an interaction between users or groups of users and entities that share a common interest as is shown with reference to block 212 of FIG. 2. In an instance in which the interest of the user or group of users matches an entity, then at block 240, the status management system 110, the interest management system 112 or the like may provide a view of or otherwise display via the user interface the users or groups of users sharing at least one of a common interest with an entity on least one of a map, information feed or the like. In one example, the users or groups of users may be provided, such as via the user interface, a visual of each entity that matches the current interest. Such visual may be presented in a map page or via another visual display presented to a user. The users or groups of users may then be able to navigate to a destination page for the entity to purchase admission, entry, a ticket, and/or reserve a table and/or otherwise interact with the entity.

Alternatively or additionally, the entity may be provided, via the user interface, a destination page or the like, the users or groups of users that are interested in the entity. For example, a sports bar may be able to see all of the users that are interested in attending a sports bar that particular evening. As such, the entity may provide offers, specials or otherwise try to interact with users. In some embodiments, the entity may be able to provide real time deals and/or ads. In some embodiments, an entity (e.g., a sports bar) may use a calendar information feed to identify groups and/or single users and subsequently provide future deals and ads. For example, providing future deals may include selecting one or more users or groups of users and providing a deal prior to (e.g., at a current time) that is good for use at a future time.

At block 242, the status management system 110, the interest management system 112 or the like may display the users or groups of users and/or the entities via the user interface based on a user credibility score. For example, users with a high user credibility score may be ranked at the top of a list and, as such, may be more aggressively targeted (e.g., may receive better offers) by entities. Similarly, users or groups of users may target those entities with higher user credibility scores. In some embodiments, the status management system 110, the interest management system 112 or the like may display the users or groups of users and/or the entities via the user interface, the user interface displaying, for example, an information feed display, of one or more users or groups of users by relevance. In some examples, relevance is a function of one or more of a location, an interest, or a social status score At block 244, the status management system 110, the interest management system 112 or the like may enable communications between entities and the users or groups of users. For example, entities may provide offers directly to the users or groups of users.

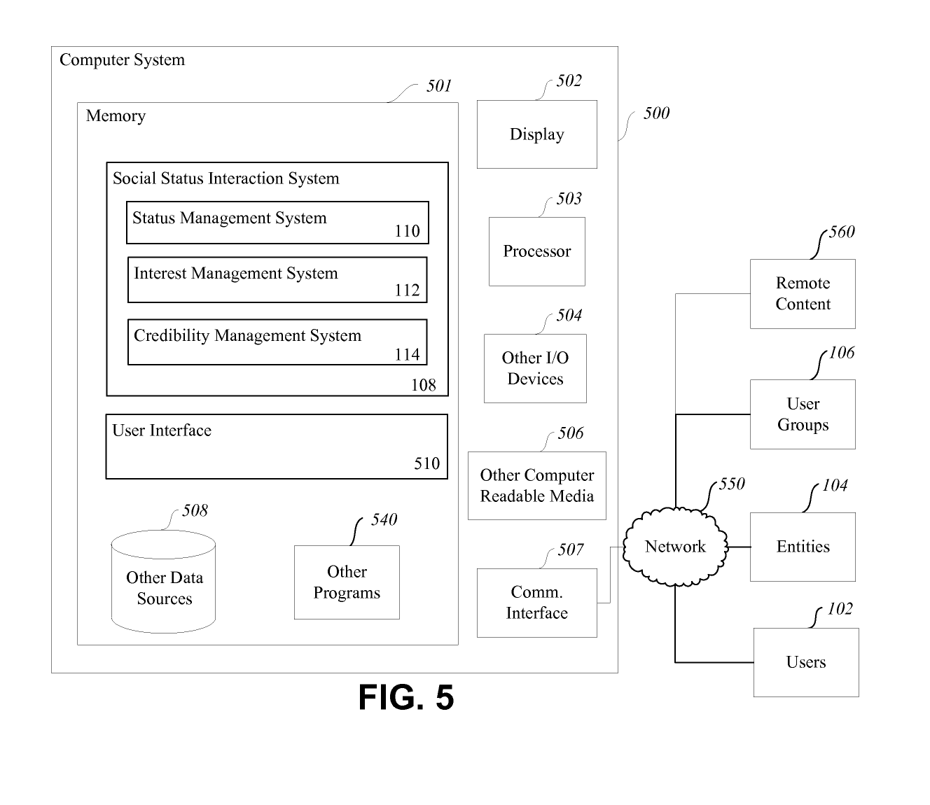

FIG. 5 is an example block diagram of an example computing device for practicing embodiments of an example social status interaction system. In particular, FIG. 5 shows a computing system 500 that may be utilized to implement a social media environment 100 having a social status interaction system 108 including, in some examples, a status management system 110, an interest management system 112, a credibility management system 114 and/or a user interface 510. One or more general purpose or special purpose computing systems/devices may be used to implement the social status interaction system 108 and/or the user interface 510. In addition, the computing system 500 may comprise one or more distinct computing systems/devices and may span distributed locations. In some example embodiments, the social status interaction system 108 may be configured to operate remotely via the network 550, such that one or more client devices may access the social status interaction system 108 via an application, webpage or the like. In other example embodiments, a pre-processing module or other module that requires heavy computational load may be configured to perform that computational load and thus may be on a remote device or server. For example, the status management system 110, the interest management system 112, and/or the credibility management system 114 may be accessed remotely. In other example embodiments, a user device may be configured to operate or otherwise access the social status interaction system 108. Furthermore, each block shown may represent one or more such blocks as appropriate to a specific example embodiment. In some cases one or more of the blocks may be combined with other blocks. Also, the social status interaction system 108 may be implemented in software, hardware, firmware, or in some combination to achieve the capabilities described herein.

In the example embodiment shown, computing system 500 comprises a computer memory (“memory”) 501, a display 502, one or more processors 503, input/output devices 504 (e.g., keyboard, mouse, CRT or LCD display, touch screen, gesture sensing device and/or the like), other computer-readable media 506, and communications interface 507. The processor 503 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application-specific integrated circuit (ASIC) or field-programmable gate array (FPGA), or some combination thereof. Accordingly, although illustrated in FIG. 5 as a single processor, in some embodiments the processor 503 comprises a plurality of processors. The plurality of processors may be in operative communication with each other and may be collectively configured to perform one or more functionalities of the social status interaction system as described herein.

The social status interaction system 108 is shown residing in memory 501. The memory 501 may comprise, for example, transitory and/or non-transitory memory, such as volatile memory, non-volatile memory, or some combination thereof. Although illustrated in FIG. 5 as a single memory, the memory 501 may comprise a plurality of memories. The plurality of memories may be embodied on a single computing device or may be distributed across a plurality of computing devices collectively configured to function as the social status interaction system. In various example embodiments, the memory 501 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In some examples, the social status interaction system 108 may be stored remotely, such that it resides in a “cloud.”

In other embodiments, some portion of the contents, some or all of the components of the social status interaction system 108 may be stored on and/or transmitted over the other computer-readable media 506. The components of the social status interaction system 108 preferably execute on one or more processors 503 and are configured to enable operation of a social status interaction system, as described herein.

Alternatively or additionally, other code or programs 540 (e.g., an administrative interface, one or more application programming interface, a Web server, and the like) and potentially other data repositories, such as other data sources 508, also reside in the memory 501, and preferably execute on one or more processors 503. Of note, one or more of the components in FIG. 5 may not be present in any specific implementation. For example, some embodiments may not provide other computer readable media 506 or a display 502.

The social status interaction system 108 is further configured to provide functions such as those described with reference to FIG. 1. The social status interaction system 108 may interact with the network 550, via the communications interface 507, with remote content 560, such as third-party content providers, and one or more client devices operated by users 102, entities 104 and/or user groups 106. The network 550 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX, Bluetooth) that facilitate communication between remotely situated humans and/or devices. In some instances, the network 550 may take the form of the internet or may be embodied by a cellular network such as an LTE based network. In this regard, the communications interface 507 may be capable of operating with one or more air interface standards, communication protocols, modulation types, access types, and/or the like. Client devices include, but are not limited to, desktop computing systems, notebook computers, mobile phones, smart phones, personal digital assistants, tablets and/or the like. In some example embodiments, a client device may embody some or all of computing system 500.

In an example embodiment, components/modules of the social status interaction system 108 are implemented using standard programming techniques. For example, the social status interaction system 108 may be implemented as a “native” executable running on the processor 503, along with one or more static or dynamic libraries. In other embodiments, the social status interaction system 108 may be implemented as instructions processed by a virtual machine that executes as one of the other programs 540. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use synchronous or asynchronous client-server computing techniques. Also, the various components may be implemented using more monolithic programming techniques, for example, as an executable running on a single processor computer system, or alternatively decomposed using a variety of structuring techniques, including but not limited to, multiprogramming, multithreading, client-server, or peer-to-peer, running on one or more computer systems each having one or more processors. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the social status interaction system 108, such as by using one or more application programming interfaces can be made available by mechanisms such as through application programming interfaces (API) (e.g., C, C++, C#, and Java); libraries for accessing files, databases, or other data repositories; through scripting languages such as XML; or through Web servers, FTP servers, or other types of servers providing access to stored data. The data sources 508 may be implemented as one or more database systems, file systems, or any other technique for storing such information, or any combination of the above, including implementations using distributed computing techniques and may provide relevant data to the status management system 110, the interest management system 112, and/or the credibility management system 114. Alternatively or additionally, the status management system 110, the interest management system 112, and/or the credibility management system 114 may have access to local data stores but may also be configured to access data from one or more remote data sources.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the social status interaction system 108 may be implemented or provided in other manners, such as at least partially in firmware and/or hardware, including, but not limited to one or more ASICs, standard integrated circuits, controllers executing appropriate instructions, and including microcontrollers and/or embedded controllers, FPGAs, complex programmable logic devices (“CPLDs”), and the like. Some or all of the system components and/or data structures may also be stored as contents (e.g., as executable or other machine-readable software instructions or structured data) on a computer-readable medium so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

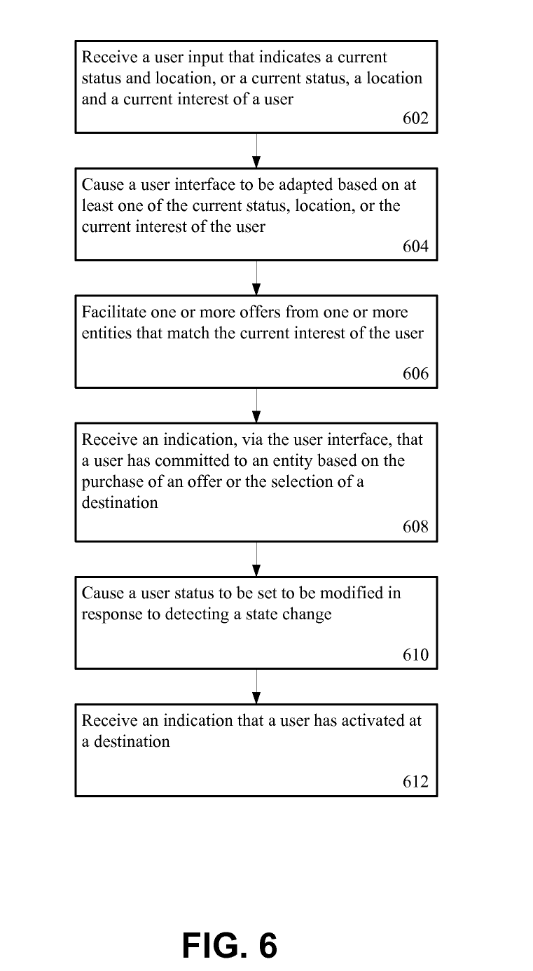

FIG. 6 is a flowchart illustrating an example interaction of a single user with the social status interaction system in accordance with some example embodiments described herein. As is shown in operation 602, an apparatus, such as computing system 500, may include means, such as the status management system 110, the interest management system 112, the processor 503, or the like, for receiving a user input that indicates a current status and a current interest of a user. For example, a user may set his/her status to active with an interest to “sports bars.” As is shown in operation 604, an apparatus, such as computing system 500, may include means, such as the status management system 110, the interest management system 112, the processor 503, or the like, for causing the user interface to be adapted based on the current status and the current interest. For example, a map or other view may be displayed that shows entities which have selected or have otherwise identified themselves as sports bars and/or those entities that have been considered by others to be sports bars, and an information news feed displaying other users active with an interest of sports bars. This interface allows, in some examples, the user to see those entities that match the stated interest so that a selection can be made. This interface may also enable a user to identify or otherwise be paired with users who share a similar interest for the evening.

As is shown in operation 606, an apparatus, such as computing system 500, may include means, such as the status management system 110, the interest management system 112, the processor 503, or the like, for facilitating one or more offers from one or more entities for the user based on the current status and the current interest. In some examples, the user may select an entity to visit (e.g., sports bar A) and then may purchase a pre-existing deal from that entity (e.g., coupon for free wings at sports bar A, admission ticket, cover charge or the like) within the user interface. In other examples, an entity may solicit business from active, and/or interested users by sending offers (e.g., an offer for free wings and a drink at sports bar B) or notifications to those users.

As is shown in operation 608, an apparatus, such as computing system 500, may include means, such as the status management system 110, the interest management system 112, the processor 503, or the like, for receiving an indication, via a user interface, that a user has selected an entity based on the purchase of an offer, selection of an entity or the like. In some examples, the current status of the user may be adjusted to committed state. For example, a user may commit to an activity either by an act, (e.g., purchasing an admission ticket or other offer) or by indicating commitment via the user interface. A selection of “commit” via the user interface, may cause or otherwise result in the display of a search bar or other input/output mechanism where the user searches for an entity, destination, event or the like, which is near the user's current or future location. Once a user is committed to a particular entity, such social state of “committed to entity”, may be posted to the news feed of other users who have been given permission to view this users social activity and who have added the user to their news feed view list.

As is shown in operation 610, an apparatus, such as computing system 500, may include means, such as the status management system 110, the interest management system 112, the processor 503, or the like, for causing a user status to change based on a detected state change or user action taken within the system. For example, a user status may be set to transporting in response to an indication that a user is traveling to the selected entity. For example, a user may order a taxi via the user interface or provide an indication to the status management system 110 that the user is currently riding in a taxi to sports bar A. Other indications may include, but are not limited to, a GPS indication, an indication by a user and/or the like. Alternatively or additionally, transporting may represent an intent to transport or otherwise travel by the user. For example, transporting may include an instance in which the user is interested in and/or otherwise ready to travel to a location but has not yet begun the trip. As such, a transport company may have access to information about the user or other groups of users based on the user or groups of user being in the transporting state and may interact with the transporting user to provide transport services. As is shown in operation 612, an apparatus, such as computing system 500, may include means, such as the status management system 110, the interest management system 112, the processor 503, or the like, for receiving an indication that a user has activated at an entity. A user may activate by taking a physical act at the entity, such as, but not limited to scanning a QR code, an exchange of a signal (e.g., Bluetooth, RFID, NFC and/or the like), barcode scan, check-in feature, GPS and/or the like. In some embodiments, one or more “state” changes may posted to the news feeds or information feeds of all users who have been given permission to view this users social activity, who have added the user to their news feed view list and/or the like. For example, a user who has been given permission by a second user to see second user's social activity may see in the user's information feed that the second user is committed to an entity. In some embodiments, in an instance in which a second user is not added to the users news feed view list, one or more state changes may not be seen in the user's information feed. In some embodiments, all state changes may be shown, whereas in other embodiments, one or more predefined state changes may be shown.

In one exemplary embodiment, “connections” may be the users or groups of users that a particular user has permitted to view or otherwise be notified of that particular user's social activity. For example, a particular user may provide an indication that the particular user gives permission to another user to view their social activity. Once such permission has been granted, the other user may choose to add the particular user to their news feed view list. Such an action may result in the social activity of the particular user being displayed in the user's “my scene” news feed, via a visual display, or the like. In some embodiments, a second particular user's social activity may not displayed in a user's news feed in an instance in which, for example, the second user has not been added to user's community at all, the second user has been added to user's community, and has been given permission by second user to view second user's social activity, but user has not chosen to add the second user to user's “my scene” news feed view list, or user has been added to second user's community, but second user did not give permission user's permission to view second user's social activity)

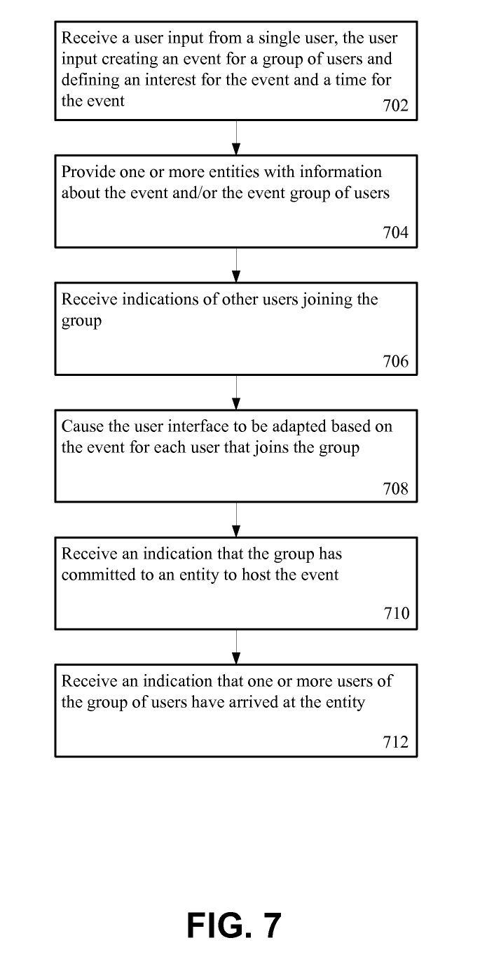

FIG. 7 is a flowchart illustrating an example interaction of a single user that is creating an event for a group with the social status interaction system in accordance with some example embodiments described herein. As is shown in operation 702, an apparatus, such as computing system 500, may include means, such as the status management system 110, the interest management system 112, the processor 503, or the like, for receiving a user input creating an event for a group of users and defining an interest, location and a time of the event. In some examples and in an instance in which a group is formed for the purposes of attending an event together, the group state may be set to building. For example, a user may identify an event of a birthday and an interest of a steakhouse and, as such, the group may build (e.g., add new members) based on those parameters. Alternatively or additionally, an event may be an event in the future and may involve travel to a new geographical location for the purposes of the event. For example, a bachelor party in Las Vegas, or a golf weekend in South Carolina may be the event setup at operation 702. In some embodiments, in either real-time or at a future time, entities may be enabled to locate one or more users or groups of users via, for example, a “user finder page” and, may further be enabled to provide real-time deals and/or future deals using, for example, a calendar news feed. In some examples, the entities may communicate with the users or groups of users.

As is shown in operation 704, an apparatus, such as computing system 500, may include means, such as the status management system 110, the interest management system 112, the processor 503, or the like, for providing one or more entities with information about the event group of users. Generally, the event will be in the future, as such, an entity may be interested in soliciting the group based on size of the group and the date of the event, and, in some embodiments, a credibility score of the group or the users in the group. The entities, in some examples, may view information about the event group via a destination page or other calendaring “user finder” interface, and then may respond with targeted deals, specials and/or the like for the group.

As is shown in operation 706, an apparatus, such as computing system 500, may include means, such as the status management system 110, the interest management system 112, the processor 503, or the like, for receiving indications of other users joining the group. As is shown in operation 708, an apparatus, such as computing system 500, may include means, such as the status management system 110, the interest management system 112, the processor 503, or the like, for causing the user interface to be adapted based on the event for each user that joins the group. In some embodiments, the apparatus may include means for causing the user interface to be adapted for each user that joins the group. For example, entities matching the interest and location of the event may be shown via the user interface once a user joins the group. In some embodiments, a status may post to a news feed of one, more than one, or all connections and/or a view of others groups who have matching or similar location and interests may be provided.

As is shown in operation 710, an apparatus, such as computing system 500, may include means, such as the status management system 110, the interest management system 112, the processor 503, or the like, for receiving an indication of at least one entity to host the event that has been identified by the group. As is shown in operation 712, an apparatus, such as computing system 500, may include means, such as the status management system 110, the interest management system 112, the processor 503, or the like, for receiving an indication that one or more users of the group of users have arrived at the entity based on those users activating at the location. In some embodiments, one or more users or groups of users may “attend” or “follow” to an event and/or entity. When a user or group of users is set to “attend” an event, “attend” may indicate that the users or groups of users plan on attending and, furthermore, the users or groups of users may receive updates regarding to and may post about the event on, for example, a news feed. When a user or group of users is set to “follow” to an event, “follow” may indicate that the users or groups of users have an interest in attending the event, and, furthermore, the users or groups of users may, additionally or alternatively, receive updates of event on each users “my scene” news feed. Either selection (e.g., attend or follow) relating to an event may result in information about the event being added to a user's “my scene” news feed. In some embodiments, users may use the calendar news feed to view future dates. In some embodiments, all (or some portion of) users who have are “following” or “attending” selections may be displayed on the calendar news feed dates in the future, and the event web page, so a user or group of users may identify who is going to what event in the future.

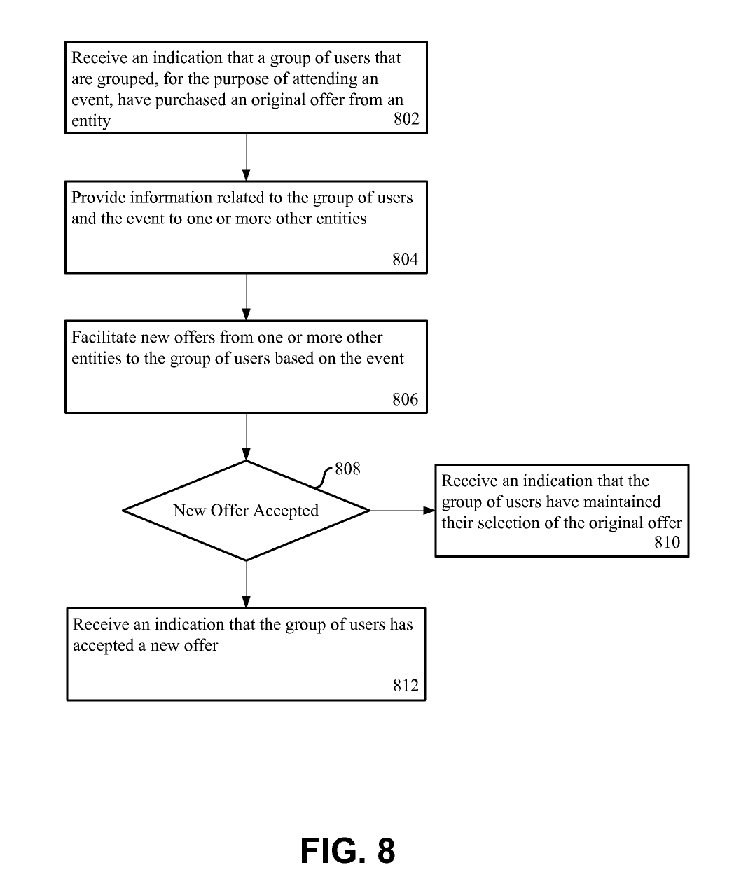

FIG. 8 is a flowchart illustrating an example interaction of a group with the social status interaction system in accordance with some example embodiments described herein. As is shown in operation 802, an apparatus, such as computing system 500, may include means, such as the status management system 110, the interest management system 112, the processor 503, or the like, for receiving an indication that a group of users that are grouped for the purpose of attending an event have purchased an original offer from an entity. For example, the event may be a birthday party and the group may have paid for admission (e.g., cover) and reserved a table at the bar. In some examples, a group may purchase offers from multiple entities, because a user and/or group may visit multiple entities within one evening or during one event that spans multiple days.

As is shown in operation 804, an apparatus, such as computing system 500, may include means, such as the status management system 110, the interest management system 112, the processor 503, or the like, for providing information related to the group of users and, optionally, in some embodiments, the event group to one or more destinations. As is shown in operation 806, an apparatus, such as computing system 500, may include means, such as the status management system 110, the interest management system 112, the processor 503, or the like, for facilitating new offers from one or more other entities to the group of users based on the event group interest, location, and credibility rating of group members. For example, another entity may try to “beat” or otherwise compete with an existing offer by sending real time, near real time or future offers to users groups that they seek to do business with.

As is shown in decision operation 808, an apparatus, such as computing system 500, may include means, such as the status management system 110, the interest management system 112, the processor 503, or the like, for determining whether a new or updated offer has been accepted. In an instance in which the new offer is not accepted, then, as is shown in operation 810, an apparatus, such as computing system 500, may include means, such as the status management system 110, the interest management system 112, the processor 503, or the like, for receiving an indication that group of users have maintained their selection of the original offer. However, in an instance in which a new offer is accepted, as is shown in operation 812, an apparatus, such as computing system 500, may include means, such as the status management system 110, the interest management system 112, the processor 503, or the like, for receiving an indication that the group of users has accepted a new offer. In some example embodiments, the status management system 110, the interest management system 112, the processor 503, or the like, may cause a refund of the original offer and may facilitate the purchase of the new offer.

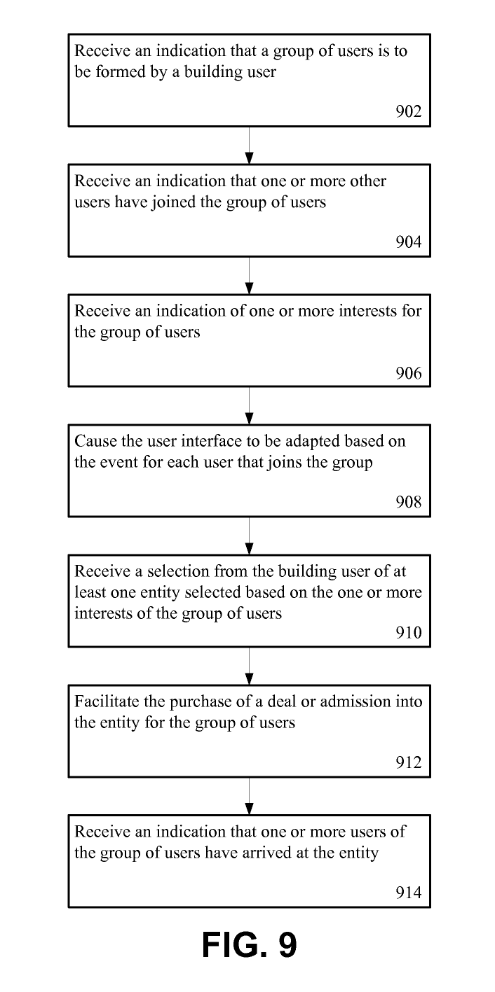

FIG. 9 is a flowchart illustrating an example interaction of a group planning for a current evening or future date with the social status interaction system in accordance with some example embodiments described herein. As is shown in operation 902, an apparatus, such as computing system 500, may include means, such as the status management system 110, the interest management system 112, the processor 503, or the like, for receiving user input indicating that a group of users is to be formed by a building user. For example, a building user may indicate, via a user interface, an interest in building a group to attend a sporting event that evening and/or go to a club. In some embodiments, a building user may indicate, via a user interface, an interest in building a group and may be provided, by the apparatus, a means for searching and/or selecting particular destinations. In some embodiments, the apparatus may include means for allowing, for example, the building user (or user given managing authority) to select one or more particular destinations and place each of one or more particular destinations in a list, queue or the like, and, allow other users to vote for one or more of the particular destinations. In some embodiments, that apparatus may include means for allowing the group to be placed on a destination user finder page. In some embodiments, due to the voting designation or the like, the apparatus may provide the group an indication of being more relevant.

In some embodiments, the apparatus may include means for facilitating formation of a group, the group comprised of the user and the one or more users, one or more of the other users able to be selected by the building user based on being provided a list of other users having matching or relevant future statuses, locations, and/or interests. In some embodiments, the system may display to “building” users, all other users (in, for example, their custom named connections group) who are “active”, “committed”, and/or “exploring” the same general location. Additionally, in some embodiments, the system may display users as most relevant whose optionally selected interest/focus matches that of the group. The system may also provide a “building” user the ability to invite such users to the user group. The system may also provide group members with a chat function to facilitate social conversation and, in some embodiments, to help determine their desired social activity. Subsequently, a builder (or authorized manager member) may invite other users to join the group. When a user joins a group, the system may then post that the user has joined the group onto the “My Scene” news feed, to another visual display or the like of all other users who have the user in their “custom named connections group”. As is shown in operation 904, an apparatus, such as computing system 500, may include means, such as the status management system 110, the interest management system 112, the processor 503, or the like, for receiving an indication that one or more other users have joined the group of users.

As is shown in operation 906, an apparatus, such as computing system 500, may include means, such as the status management system 110, the interest management system 112, the processor 503, or the like, for receiving an indication of one or more interests for the group of users. In some examples, a building user may define the interests of a group, however in other cases a vote or other discussion may occur to determine the interests of the group. In some embodiments, when a group sets an interest or focus, the interest and/or focus may be posted to the “my scene” news feed of other users who have a member of the group in their “custom named connections group” subject to privacy settings. Further, the system may provide a builder (or authorized manager member with the ability to “commit” the group to a particular location, via a destination/event search bar. When a group selects a particular destination/event and “commits” to this particular destination/event, the system may post this group as “committed” to the particular destination/event. The system may post this status update to the “my scene” news feed of other user(s) (i.e., users outside the group) if the other users have added any member of the group to their “custom named connections group”. As is shown in operation 908, an apparatus, such as computing system 500, may include means, such as the status management system 110, the interest management system 112, the processor 503, or the like, for causing the user interface to be adapted based on the event for each user that joins the group.

As is shown in operation 910, an apparatus, such as computing system 500, may include means, such as the status management system 110, the interest management system 112, the processor 503, or the like, for receiving a selection from the building user of at least one desired location selected from the one or more interests for the group of users. Similarly to the defining of interests, the building user may act as a leader and select the location or entity that they group will attend or may leave it up to the group to decide based on a vote, discussion or the like. In further examples, multiple interests can be defined by a group and, as such, multiple entities may be selected by the group. For example, dinner and a movie, a basketball game and a club and/or the like.

As is shown in operation 912, an apparatus, such as computing system 500, may include means, such as the status management system 110, the interest management system 112, the processor 503, or the like, for facilitating the purchase of any entry fees into the at least one desired location. For example, the group can purchase entry fees, tickets, coupons or the like as a group or each user can be prompted to purchase individually. As is shown in operation 914, an apparatus, such as computing system 500, may include means, such as the status management system 110, the interest management system 112, the processor 503, or the like, for receiving an indication that one or more users of the group have arrived at the desired location.

FIG. 10 is a flowchart illustrating example user credibility scoring of a single user interacting with the social status interaction system in accordance with some example embodiments described herein. As is shown in operation 1002, an apparatus, such as computing system 500, may include means, such as the social status interaction system 108, the credibility management system 114, the processor 503, or the like, for causing a user credibility score to increase based on a received user input that sets a current status and a current interest. In some examples, any user interaction may result in an increase in the user credibility score, whereas any time a user fails to perform has indicated a user credibility score may be decreased. As such, the user credibility score may function as an incentive for a user to follow through with commitments made in the digital world (e.g., the social status interaction system) and to continually funnel a user to an interaction in the physical world (e.g., an interaction at an entity or other users). In some example embodiments, entities may also be assigned a credibility score based on user experiences, reviews, participation, the creation of deals/offers, and/or the like.

As is shown in operation 1004, an apparatus, such as computing system 500, may include means, such as the social status interaction system 108, the credibility management system 114, the processor 503, or the like, for causing a user credibility score to increase in response to a received indication that a user has selected a desired location, purchased an offer and/or a current status has otherwise been adjusted to committed. In some examples, the closer that a user gets to a physical interaction, the greater the increase in the user credibility score. In other cases, a purchase transaction may be worth a larger increase in user credibility score over a simple indication of commitment because of a higher level of commitment that may be attributed to the fact that the user spent money. For example, it is more likely a user will visit the sports bar if he/she has already purchased an offer.

As is shown in operation 1006, an apparatus, such as computing system 500, may include means, such as the social status interaction system 108, the credibility management system 114, the processor 503, or the like, for causing a user credibility score to increase in response to a detected state change. For example, in an instance in which a current status is set to transporting, committed, or the like. In some examples, the user credibility score may be increased in an instance in which a user activates (e.g., scans a QR code, passes an RFID reader or the like) at a mode of transportation, such as a taxi, train, bus or the like. Alternatively or additionally, GPS indications, activating at a parking lot, a user indication or entry and/or the like may also provide an indication that a user is transporting to a location and, as such, may result in the user receiving an increase in user credibility score.

As is shown in decision operation 1008, an apparatus, such as computing system 500, may include means, such as the social status interaction system 108, the credibility management system 114, the processor 503, or the like, may be configured to determine whether a user has activated or has otherwise checked in at a desired location. In an instance in which a user has activated at a desired location, then, as is shown in operation 1012, an apparatus, such as computing system 500, may include means, such as the social status interaction system 108, the credibility management system 114, the processor 503, or the like, for causing a user credibility to rise. As is shown in operation 1014, an apparatus, such as computing system 500, may include means, such as the social status interaction system 108, the credibility management system 114, the processor 503, or the like, for adjusting the change in user credibility score based on a price of an activity at the desired location, type of transaction and/or a time investment at a desired location. For example, a two hour movie may result in a larger increase to a user credibility score than a fifteen minute visit to a sports bar.

Alternatively or additionally, a credibility score of an entity may rise in an instance in which a user activates. Similarly, an employee of an entity may also receive an increase in credibility if he/she is able to recruit a user or group of users to activate at a desired location.

In an instance in which a user has not activated at a desired location (e.g., the location of the entity to which the user committed), then, as is shown in operation 1010, an apparatus, such as computing system 500, may include means, such as the social status interaction system 108, the credibility management system 114, the processor 503, or the like, for causing a user credibility score to decrease.

FIG. 11 is a flowchart illustrating example user credibility scoring of a group of users interacting with the social status interaction system in accordance with some example embodiments described herein. As is shown in operation 1102, an apparatus, such as computing system 500, may include means, such as the social status interaction system 108, the credibility management system 114, the processor 503, or the like, for causing a user credibility to increase for a building user based on the building user initiating a group event. As is described above, any interaction with the social status interaction system 108 may result in an increase in user credibility score, however a user who builds a group of users, and, therefore, motivates a larger group to participate in the physical world may receive an additional increase in user credibility score.

As is shown in operation 1104, an apparatus, such as computing system 500, may include means, such as the social status interaction system 108, the credibility management system 114, the processor 503, or the like, for causing a user credibility score to increase for a building user and for a user in each instance that a new user joins a group. For example, each time a user joins the group, that user and the building user will receive an increase in user credibility score. As is shown in operation 1106, an apparatus, such as computing system 500, may include means, such as the social status interaction system 108, the credibility management system 114, the processor 503, or the like, for causing a user credibility score for the building user and for each user in the group to increase based on a received current interest.

As is shown in decision operation 1108, an apparatus, such as computing system 500, may include means, such as the social status interaction system 108, the credibility management system 114, the processor 503, or the like, may determine whether the users of the group activate at a location. In an instance in which the group activates at a location, then, as is shown in operation 1112, an apparatus, such as computing system 500, may include means, such as the social status interaction system 108, the credibility management system 114, the processor 503, or the like, for causing a user credibility score to increase. As is shown in operation 1114, an apparatus, such as computing system 500, may include means, such as the social status interaction system 108, the credibility management system 114, the processor 503, or the like, for adjusting the change in user credibility score for the building user and each user in the group based on a price of an activity at the desired location, type of activation at the desired location, type of transaction and/or time investment at the desired location.

In an instance in which the group does not activate at a location, then, as is shown in operation 1110, an apparatus, such as computing system 500, may include means, such as the social status interaction system 108, the credibility management system 114, the processor 503, or the like, for causing a user credibility score to decrease for the building user, authorized group manager or managers. In some examples, a user credibility score is decreased in an instance in which the group had committed, in some examples the entire group may also have a credibility score reduced. In some examples, the building user or authorized group manager or managers may receive a larger decrease in user credibility score.

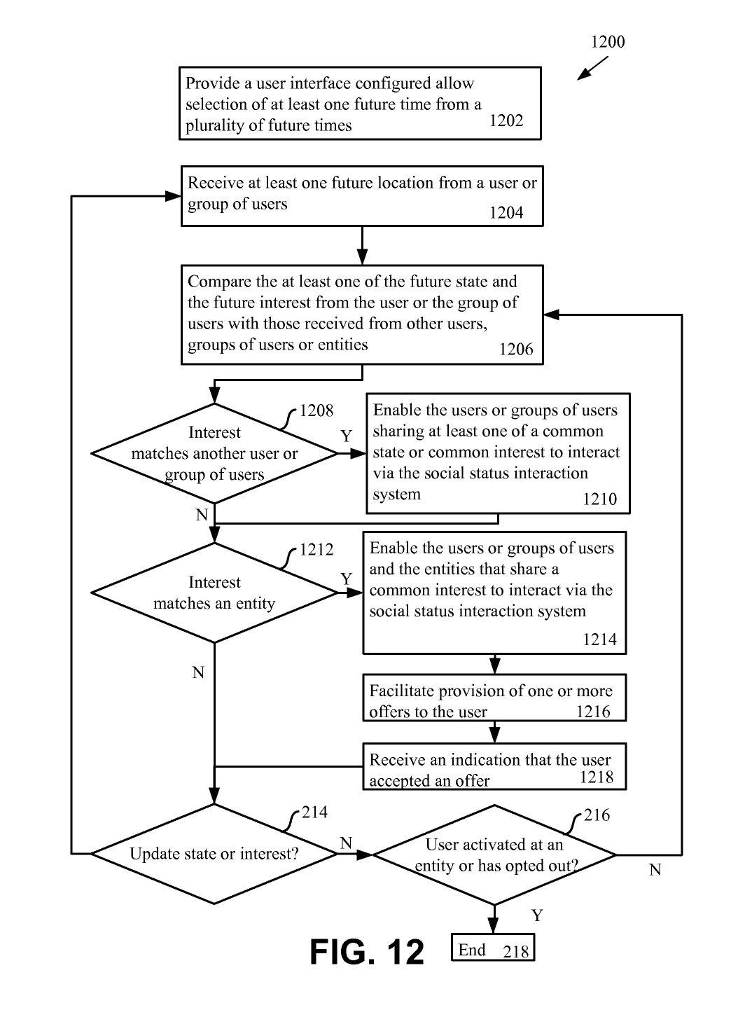

FIG. 12 illustrates an example flowchart that may be performed by the social status interaction system 108 in accordance with some example embodiments of the present invention. Many functions of the status management system 110 and the interest management system 112 have been previously described with respect to FIGS. 1-11.

FIG. 12 will be described with reference to example displays 1400, 1500, and 1550 shown in FIGS. 14, 15A, and 15B, respectively. FIGS. 14, 15A, and 15B show example displays 1400, 1500, and 1550 that may be presented by one or more display screens of one or more devices, such as those used by a first user, second user, an entity, a group of users or the like. Again, while the example displays 1400, 1500, and 1550 are configured to be shown on a computer display, mobile device, wearable device, “tablet computer” or other device having similar dimensions, similar interfaces may be utilized with other types of devices discussed herein and modified accordingly (e.g., for screen size, input device compatibly, ease of use, etc.). And again, in some embodiments, any physical device may be configured to perform the functionalities described herein.

Returning now to FIG. 12, as is shown in block 1202, the status management system 110, the interest management system 112 or the like may provide a user interface configured allow selection of at least one future time, time frame, date, reservation or the like from a plurality of future times. In some embodiments, the user interface may comprise or be configured to provide a calendaring function or, in some embodiments, be displayed as a calendar. The calendar may show a day, a week, a month, a year or the like. In some embodiments, the calendar may show a specified, default, or predefined time range.

For example, display 1400 of FIG. 14 shows a display screen that may be displayed by a device. Display 1400 may be configured to display news feed 1404 related to the user. Display 1400 may also comprise calendar 1408. Additionally, display 1400 may be configured to provide one or more other portions indicative of other information or functionality. For example, news feed 1404 may provide the user with an indication of which date the user has selected to view information for, what their currently selected or stated status or interest is for that future date or the like. Display 1400 may also allow the user to view other users or groups of users (“groups”) that match location, interest, state or the like based on relevance for the selected time period. In some embodiments, display 1400 may also display one or more indications or icons 1406 representing one or more additional layers. For example, the indications may include but are not limited to a privacy indication, a security indication, a graphic edit indication, a text edit indication, and an inaccurate information indication. Still further, in some embodiments, display 1400 may also be configured to display one or more of the indications related to pin placement, text box placement, additional information, bug reporting, status point allocation, data point allocation, user tutorials, each indication indicative of an additional layer.

In some embodiments, an indication for a layer, a mobile option for activation or the like allowing the user to change status may be provided. For example, the user may select an icon indicative of a new status, a status change, or the like, and display 1400 may be configured to display a search bar optionally with destination or event filters, a list of entities, or the like, and allow selection. The status management system 110, the interest management system 112 or the like may be configured to allocate status points or alter the user's news feed or other's news feed accordingly. In some embodiments, an indication for a function allowing the user to activate, or simply an activation icon may be provided. Once selected, the status management system 110, the interest management system 112 or the like may provide a QR code (or other bar code, pattern or the like) scanner, a search bar, or the like, allowing the user to activate at a location, entity or the like. Again, status points may be allocated, the user's news feed may be updated accordingly, and other's news feeds may be updated accordingly as well.

As such, as is shown in block 1204, the status management system 110, the interest management system 112 or the like may receive user input that indicates the at least one future time and a future location of a user or group of users (e.g., the one or more users 102a-102n and the one or more user groups 106a-106n) at the at least one future time. For example, by selecting the calendar 1408 and a specific date (e.g., the 24^{th}), range of dates (e.g., the 14^{th}-16^{th}), time, or any future period or point of time, a user may input a future location. In some embodiments, the status management system 110, the interest management system 112 or the like may receive user input that indicates at least one of a future status or a future interest and a location. This may provide, for example, users the ability to set their social activity status for future days, to be viewed by other users via their calendar news feed function.

Subsequently, as is shown in block 1206, the status management system 110, the interest management system 112 or the like may compare the at least one future time and future location from the user or the group of users with those received from other users, groups of users or entities and determine that the user and at least one or more users, groups of users, or one or more entities have a matching at least one time and future location. For example, as shown in display portion 1416, Groups 1-3 and users 2-4 may be displayed as matching a state and location of the user. In some embodiments, the status management system 110, the interest management system 112 or the like may receive at least one future interest, and then use the at least one future interest in the comparison to determine a relevance or an order in which to display users or groups of users matching the state and location. In some embodiments, display 1400 may be configured to allow selection of a view type (e.g., all, users, groups, or the like), which are shown as icon 1410, 1412, and 1414. Accordingly, the status management system 110, the interest management system 112 or the like may facilitate interaction between the user and the one or more users or the one or more entities, which is more fully described below. In some embodiments, display 1400 may provide an icon allowing the user to chat or real time message with one or more users, groups, or entities, by for example, enabling selection of one or more users, groups, or entities, and then enabling selection of the chat icon 1420. Thus, the status management system 110, the interest management system 112 or the like may enable access to at least one of a future status or future statuses or the future interest(s) of the user.

In some embodiments, in order to determine to whom (e.g., which one or more users, groups of users, or entities) access may be enabled, as is shown in block 1208, the status management system 110, the interest management system 112 or the like may determine one or more users and/or groups of uses that match at least one of the future status and future location or, in some embodiments, the future status, the future location, and the future interest of the user, and as such, as shown in block 1210, the one or more users that match at least one of the future status and future location or the future status, the future location, and the future interest of the user are provided with access to information related to the user and the user is provided with access to information related to the one or more users. Additionally or alternatively, as is shown in block 1212, the status management system 110, the interest management system 112 or the like may determine one or more entities that match at least one of the future status and future location or the future status, the future location, and the future interest of the user, and as such, as shown in block 1214, the one or more entities that match at least one of the future status and future location or the future status, the future location, and the future interest of the user are provided, in some examples, with access to information related to the user and the user is provided with access to information related to the one or more entities. In some embodiments, a user may be further provided access to information related to entities/events the user or other users are “following” or “attending” (in case of events, either of these two options).

By way of further example, displays 1500 and 1550 show user finder pages for entities. As can be seen, entities may be shown information related to users. Display 1500 and display 1550 differ in that display 1500 shows a user finder page showing real time information whereas display 1550 shows a user finder page for a future time. For example, display 1500 may be configured to display an icon 1504 displaying a current time (e.g., real time) that, when selected, may switch to a future time. Alternatively, the icon may be for informational purposes only, indicating that the entity is viewing real time information. In some embodiments, the calendar 1506 of display 1500 may appear hidden, faded or the like indicating that it is not in use. In some embodiments, displays 1500 or 1550 may appear with a day for which the information provided is provided, highlighted or otherwise indicated.

As shown in block 1216, the status management system 110, the interest management system 112 or the like may facilitate the one or more entities to provide one or more offers based on one of the future status, location, or the future interest of the user at the at least one future time. For example, display 1400 may be configured to provide a user with access to such offers by providing an offers or deals notification icon 1418 and allowing selection, which may then display one or more offers or deals. The offers or deals that are displayed may be related to selected dates, selected users or groups, selected entities, all available or any other desirable (e.g., via a predefined selections) format. In some embodiments, one or more offers or deals may be displayed in a different layer than display 1400. In another exemplary embodiment, displays 1500 and 1550 may provide create deal icon 1508 and create ad icon 1510. The status management system 110, the interest management system 112 or the like may be configured to allow selection of one or more users or groups of users (e.g., group 1, group 2, and user 2 are selected in FIGS. 15A and 15B), and receive an indication that the entity will create a deal or ad which will be directed to the selected users and groups. In some embodiments, once an entity provides an indication to create a deal or offer, a template may be displayed, the template being, for example, a different layer, a pop up interface or the like, and displaying selectable or places to input one or more of price, description, time, and the like. In some embodiments, one or more previously created or offered deals or offers may be available for selection or editing.

As shown in block 1218, the status management system 110, the interest management system 112 or the like may receive an indication that the user accepted or purchased an offer from the one or more offers provided by the entity. In some embodiments, the status management system 110, the interest management system 112 or the like may be configured to charge a fee for sending each of one or more deals or advertisements. In some embodiments, the status management system 110, the interest management system 112 or the like may be configured to allocate status points to entities that create and/or send deals or advertisements. In some embodiments, the status management system 110, the interest management system 112 or the like may be configured to base charges on the specific dates or range of dates the deal or advertisement is sent or created, base charges on how far in the future a deal or advertisement is created for or the like.

In an instance in which a future interest of the user or group of users does not match an entity, then at decision block 214, the status management system 110, the interest management system 112 or the like may determine whether a user or a group of users has updated a future state, a future location, or an interest. For example, a user may have indicated an interest in sports bars on a day in which no major sports are being played and, as such, the user may select a new interest. In an instance in which a user or a group of users has updated a future state, future location, or an interest, then the process returns to block 1204. In an instance in which a user or a group of users has not updated a state, location or an interest, then at decision block 216, the status management system 110, the interest management system 112 or the like may return to block 1206.

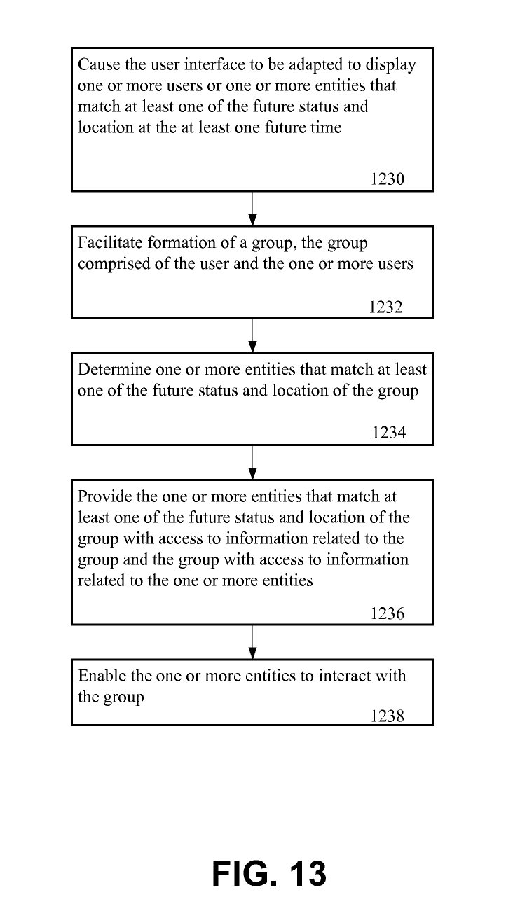

FIG. 13 illustrates an example flowchart that may be performed by the social status interaction system 108 in accordance with some example embodiments of the present invention. In some embodiments, as shown in block 1230, the status management system 110, the interest management system 112 or the like may cause the user interface to be adapted to display one or more users or one or more entities that match at least one of the future status and future location or, in some embodiments, a future state, a future location, and a future interest of the user at the at least one future time. Subsequently, as shown in block 1232, the status management system 110, the interest management system 112 or the like may facilitate formation of a group, the group comprised of the user and the one or more users.

In some embodiments, once the group is formed, as shown in block 1234, the status management system 110, the interest management system 112 or the like may determine one or more entities that match at least one of the future status and future location or, in some embodiments, the future status, the future location, and the future interest of the group, and as shown in block 1236, the one or more entities that match at least one of the future status and a future location, or in some embodiments, a future status, a future location, and a future interest of the group are provided with access to information related to the group and the group is provided with access to information related to the one or more entities. In some embodiments, again as shown in block 1234, the status management system 110, the interest management system 112 or the like may determine one or more entities that match at least one of the future status or, in some embodiments, the future status, the future location, and the future interest of the group. And accordingly, as shown in block 1238, the status management system 110, the interest management system 112 or the like may enable the one or more entities to interact with the group.

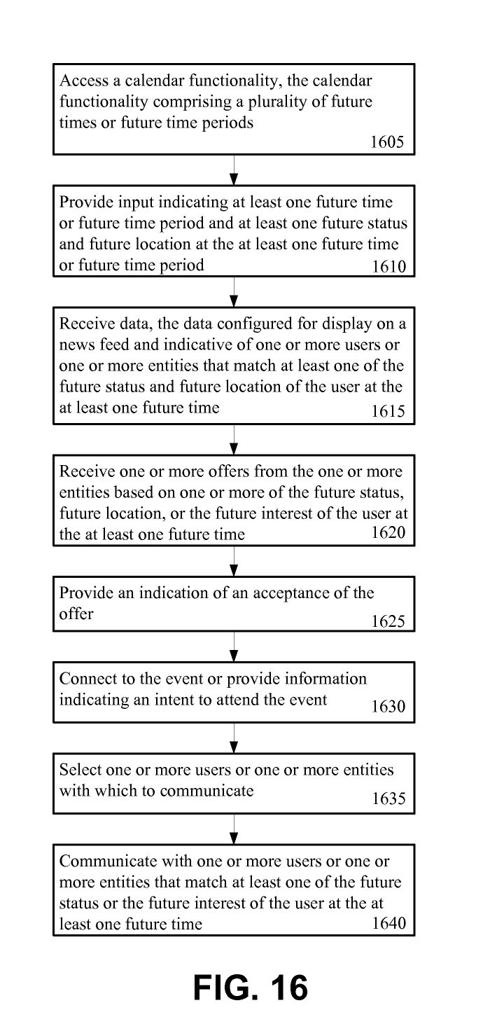

FIG. 16 illustrates an example flowchart that may be performed by a user device, such as a cell phone, a tablet, or the like, interacting with or configured to interact with the social status interaction system 108 in accordance with some example embodiments of the present invention. As shown in block 1605 of FIG. 16, the user device may be configured to access a calendar functionality, the calendar functionality comprising a plurality of future times or future time periods. For example, referring back to FIG. 14, the user may access the calendar 1408.

Subsequently, as shown in block 1610 of FIG. 16, the user device may be configured to provide input indicating at least one future time or future time period and at least a future status and a future location at the at least one future time or future time period. Again, referring back to FIG. 14, the user may select the 16^{th} or, in some embodiments, a future time period such as the weekend of the 14^{th} and 15^{th} may be selected. In some embodiments, the user device may be configured to provide input indicating a future social status such as “active”, a location, and a particular interest.

Once the dates are selected and a status and location is input, as shown in block 1615 of FIG. 16, the user device may be configured to receive data, the data configured for display on a news feed and indicative of one or more users or one or more entities that match at least one of the future status and the future location of the user at the at least one future time. Referring, again, back to FIG. 14, the information may be displayed on the news feed 1416.

In some embodiments, an entity or entities may send an offer to the user based on the status, interest, the time period, or the like. As such, as shown in block 1620 of FIG. 16, the user device may be configured to receive one or more offers from the one or more entities based on one of the future status and future location or, in some embodiments, the future status, the future location, and the future interest of the user at the at least one future time. Once the offer is received, as shown in block 1625 of FIG. 16, the user device may be configured to provide, in some embodiments, notification that the offer is received and in some embodiments, an indication of an acceptance of the offer.

In some embodiments, the news feed may display an entity providing or hosting an event matching the future interest of the user during or near the future time period. The user may wish to follow or attend the event in order to, for example, receive more information or communicate to other users or groups of users that they intend to attend. Accordingly, as shown in block 1630 of FIG. 16, the user device may be configured to follow the event or provide information indicating an intent to attend the event.

In some embodiments, a user may view the “my scene” news feed and want to communicate with one or more of the users, groups of users, or the entities that are displayed. Accordingly, as shown in block 1635 of FIG. 16, the user device may be configured to select one or more users or one or more entities with which to communicate. Subsequent to selecting the one or more users and/or one or more entities, as shown in block 1640 of FIG. 16, the user device may be configured to communicate with one or more users, groups, or one or more entities that match at least one of the future status and future location or the future interest of the user at the at least one future time.

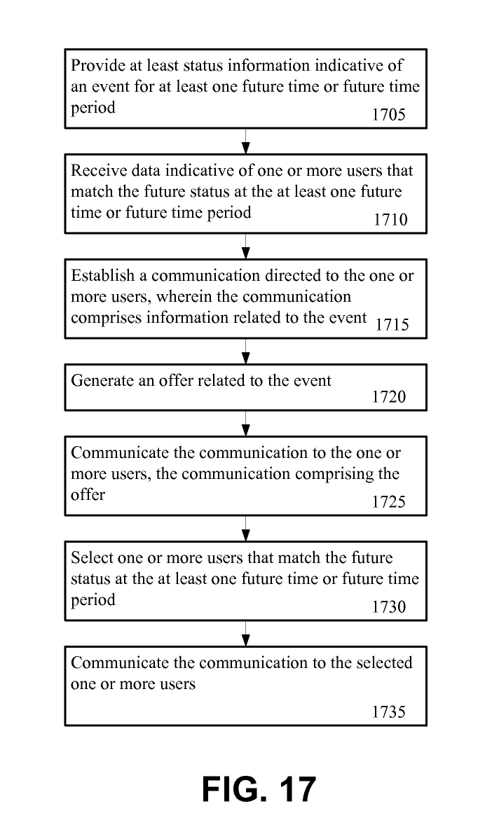

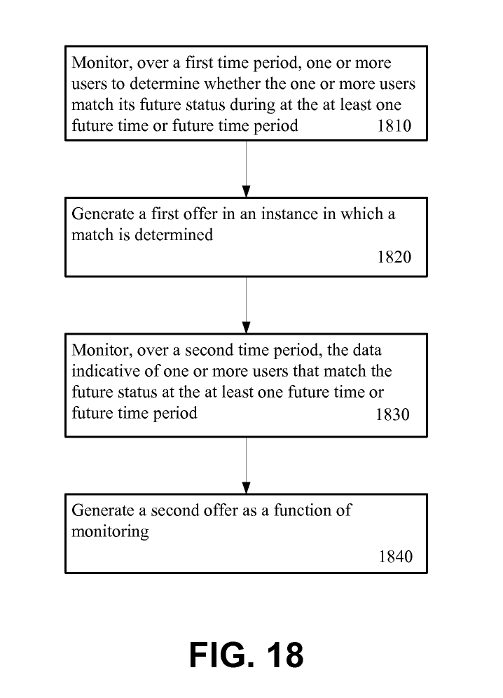

FIGS. 17 and 18 illustrate example flowcharts that may be performed by, for example, an entity device interacting with or configured to interact with the social status interaction system 108 in accordance with some example embodiments of the present invention. As shown in block 1705 of FIG. 17, the entity device may be configured to provide at least status information indicative of an event for at least one future time or future time period. For example, an entity may indicate “live music”, “comedy”, or the like for a future time. As shown in block 1710 of FIG. 17, the entity device may be configured to receive data indicative of one or more users that match the future status at the at least one future time or future time period. For example and with reference to FIG. 15A, the entity may view a “user finder page” and see those users or groups of users who have input a future status and a future location, or, in some embodiments, a future status, a future location, and a future interest matching or relevant to one or more of its scheduled event. In some embodiments, when a future time arrives, entities may be able to view such matching users in real time or near real time, as their status that was set in the future is now current to this day, and is displayed by the system.

In some embodiments, the entity may communicate with the users or groups of users matching the posted status or event in order to, for example, convey additional information or provide an offer, deal, or the like. As such, as shown in block 1715 of FIG. 17, the entity device may be configured to establish a communication directed to the one or more users, wherein the communication comprises information related to the event. As shown in block 1720 of FIG. 17, the entity device may be configured to generate an offer related to the event.

FIG. 18 shows an exemplary process for generating offers to, for example, different users or groups of users As shown in block 1810 of FIG. 18, the entity device may be configured to monitor, over a first time period, one or more users to determine whether the one or more users match its future status and location during at the at least one future time or future time period. As shown in block 1820 of FIG. 18, the entity device may be configured to generate a first offer in an instance in which a match is determined. In some embodiments, the entity may continue to monitor users or groups of users that match the future status, and location during the at least one future time or future time period. As more users or groups of users match, in some embodiments, an offer may change. For example, in an instance in which there are more matching users, the entity may no longer have to provide an offer to attract users. Whereas, in some embodiments, as an event draws near, an additional offer may be provided to attract the users or groups of users in an instance in which there are not enough matching users or groups of users. Accordingly, as shown in block 1830 of FIG. 18, the entity device may be configured to monitor, over a second time period, one or more users that match the future status and location at the at least one future time or future time period. As shown in block 1840 of FIG. 18, the entity device may be configured to generate a second offer as a function of monitoring.

Returning now to FIG. 17, once an offer is generated, the entity device may be configured to communicate that offer to the users or groups of users that match the future status. The offer may be communicated at the time the match is found where the offer already exists to an open class of matching users or groups of users, at a time selected by the entity (e.g., a current time of generating the offer or an amount of time thereafter), or at the at least one future time or future time period when a threshold of users or groups of users is reached. As such, as shown in block 1725 of FIG. 17, the entity device may be configured to communicate the communication to the one or more users, the communication comprising the offer. In some embodiments, an entity device may be configured to communicate particular communications or offers to selected users or groups of users. Accordingly, as shown in block 1730 of FIG. 17, the entity device may be configured to select one or more users that match the entity by status, location, interest/focus, at the at least one future time or future time period, and subsequently, as shown in block 1735 of FIG. 17, the entity device may be configured to communicate the communication to the selected one or more users.

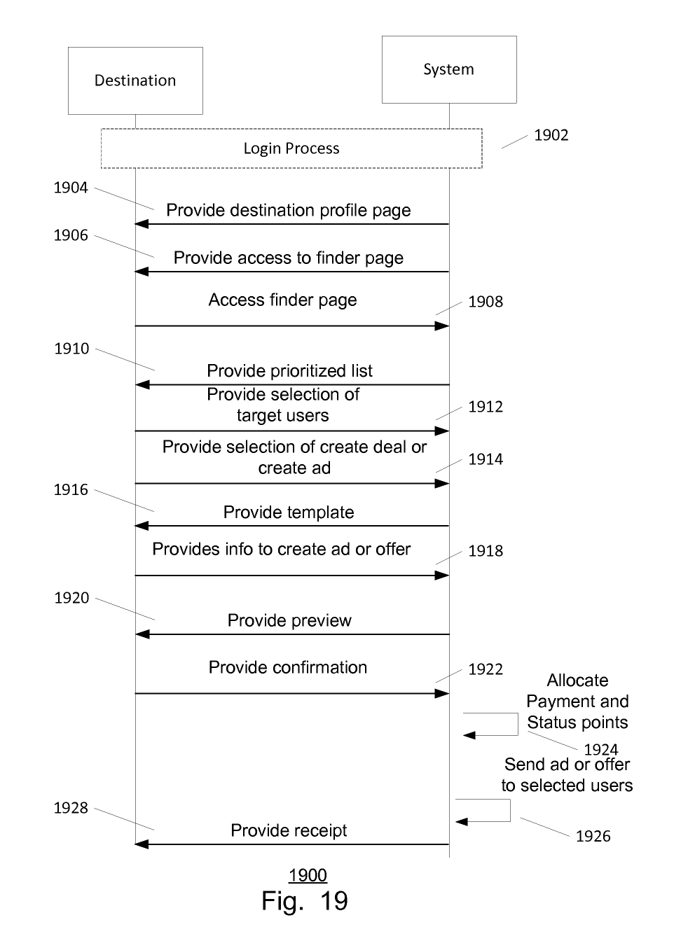

In one exemplary embodiment, an entity may generate a destination and, in order to generate attendance, notice or the like, may additionally generate offers or advertisements. As such, FIG. 19 shows a data flow diagram of an example data flow represented by method 1900 by the social status interaction system 108 and an entity device, in accordance with some example embodiments of the present invention. At 1902 a login process may be performed. For example, an entity device may navigate to a webpage or execute a mobile application associated with the social status interaction system. At 1904, the system may provide a destination profile page, the destination profile page being a profile page associated with an entity, an event, or the like. At 904, the system may provide access to a user finder page. For example, in one embodiment, the system may present a destination profile page with an ability to access a “Find Socialtopian/Entourage function”. As such, at 1908, destination profile page, the finder page, or the destination profile page and an associated ability to access the finder page function may be accessed.

At 1910, the system may provide a list of prioritized users by relevance and/or status. In some embodiments, the system may also provide an ability to filter the view by: user, groups of users (e.g., “socialtopians”, “entourages”), all, or the like. Relevance may be based on (1) location (e.g., city, neighborhood, or the like), (2) status or social state (e.g., “active”, “roaming”, “exploring”, “building” and the like) and (3) one or more selected interest/focuses from, for example, a tag cloud or the like, and/or user preferences. In some embodiments, relevance related to a group of users (e.g., entourage relevance) may be based on (1) “in queue”—meaning the destination has been selected and placed by the builder of the entourage into the “destination queue”, such that entourages may appear at the very top of the page as they are most relevant; (2) location, and in some embodiments, higher relevance may be associated with a neighborhood and decrease with city, state, and region of country; (3) matching interest/focus from tag cloud or the like; (4) users and groups of users with higher credibility ratings (5) entourages that have previously purchased a deal from this location; (6) entourages that have previously activated there or builders who have activated there. In some embodiments, the system may be configured to display users and/or groups of users (e.g., Socialtopians and/or entourages) by name, credibility/social status level (for example, represented by one or more colors (e.g., green, blue, purple), social state, and the status location of interest/focus.

At 1912, the destination may select one or more users and/or groups of users and provide the selection to the system. At 1914, the destination may provide an indication to create an offer or an advertisement to the selected users or groups of users. As shown at 1916, the system may provide a template, form or series of forms, or the like for aiding in the creation of an offer or advertisement. In some embodiments, the system may provide a template with one or more portions, each portion of the template indicative of information that may be used in the advertisement. For example, the template may request information related to the destination (e.g., a title, a description, a price, a time available, a related picture that may be linked to or uploaded, etc.). In some embodiments, the system may provide previously started and save and/or previously created offers or advertisements as a template. Once the destination provides the information, the system may generate a preview of the offer or advertise and provide the preview to the destination in 1918. If the preview is not acceptable, the destination may choose to edit or start over. However, the destination may confirm acceptance, at 1922, of the offer or advertisement, for example, if the destination finds the offer or acceptance accurate.

At 1924, the system may allocate payment for the offer or advertisement from, for example, an account associated with the destination to, for example, an account associated with the system. Additionally or alternatively, the system may allocate status points to the destination. At 1926, the system may send the offer or an offer notification to the users or groups of users selected to receive the offer or advertisement, or in some embodiments, the system may send an advertisement to an advertisement viewing area of, for example, a webpage or mobile application. At 1928, the system may provide a notification and/or receipt to the destination regarding the offer or advertisement, the payment, the status points, or the like.

In one exemplary embodiment, at, for example, 1926 the system may send a notification of the offer to the selected user or each member of the selected group of users. When the user selects this notification, the system may display the offer details as put forth by the destination, and enables the user to purchase the offer at that time via a credit card payment or other method. Once payment has occurred, the deal is accepted, and the system allocates status points to the user and the destination for a successful transaction.

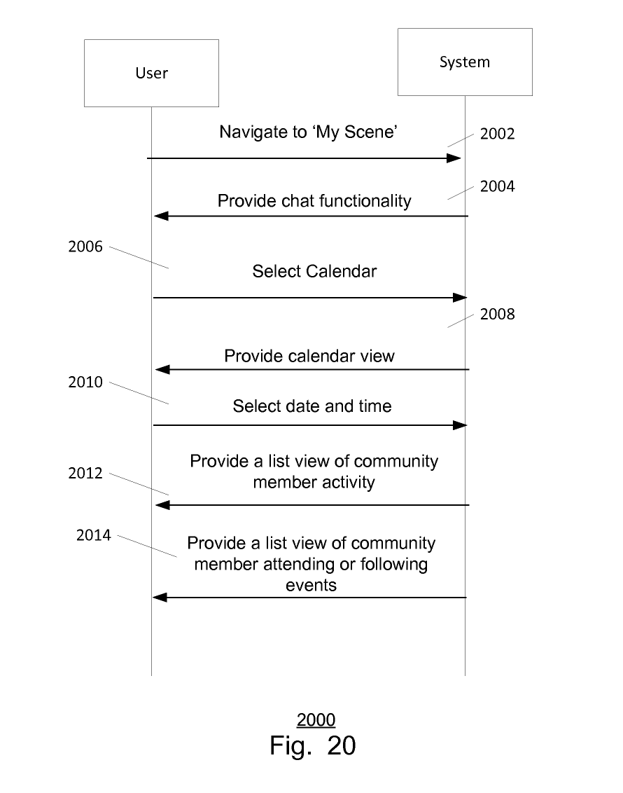

In one exemplary embodiment, a user may use the system to view a calendar to view real time and/or future social activity and other community member attendance thereof. FIG. 20 shows a data flow diagram of an example data flow represented by method 2000 by the social status interaction system 108 and a user device, in accordance with some example embodiments of the present invention.

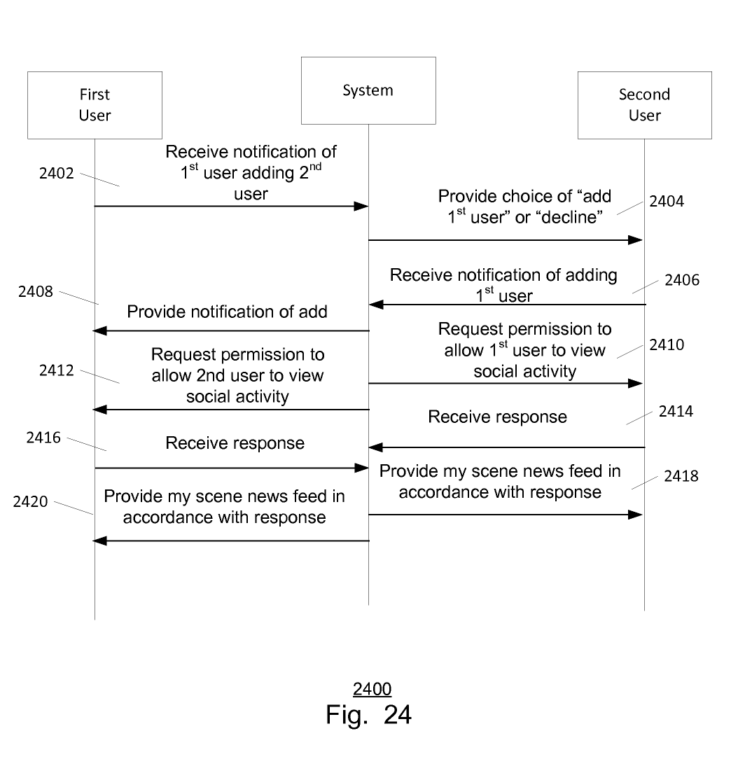

At 2002, the user navigates to a page, such as “My Scene”, a news feed page, or the like. The system may display other users which pursuant to, for example, a process, which is further described with reference to FIG. 24, have been placed in the users “custom named connections groups”. Users may be displayed based on relevant matching location, social status (e.g. “active”) and, in some embodiments, selected interest/focus (e.g. sports bar). In some embodiments, such a display list will be in order of relevance determined by (1) Location with matching social state and optionally selected interest/focus (2) location, with matching social state (3) Location with no matching social state or interest. User groups may also displayed by the system if, for example, any member of the group is in the users “custom named connections group”. This page may be displayed by a design similar to FIG. 14. In some embodiments, as shown at 2004, the system may provide a communication functionality, such as a chat function, a messaging service or the like, for example, be utilized to make plans. In some embodiments, the chat functionality may include a group chat function. Group chat function may include a “create entourage/group” selection with group chat members. When “create entourage/group” is selected, the system may then set the selecting user to “building” and present an entourage/user group creation template. This group chat to group creation function may facilitate creation of active entourage groups capable of acting in the social status system. Once created, entourages may still have the chat function, but may also act in the social status system as discussed above.

At 2006, the user may then select a calendar functionality. In response, as shown at 2008, the system may provide a calendar view. In some embodiments, the calendar view may be provided such that different colors may be displayed on one or more different dates, each color corresponding to an amount of activity or a type of activity For example, in some embodiments, green may be an indication of any amount of activity where between 1 and 10 users on the “my scene” news feed are showing activity, and purple may be representative of more than 10 users on the “my scene” news feed showing future activity.

At 2010, the user may then select a particular date, and in some embodiments, time. At 2012, the system may then provide a list view of the user's community member's activity as set by, for example, a social state update system on the selected date. At 2014, the system may, additionally or alternatively, provide a list view of community member activity related to events or destinations that users are attending or following.

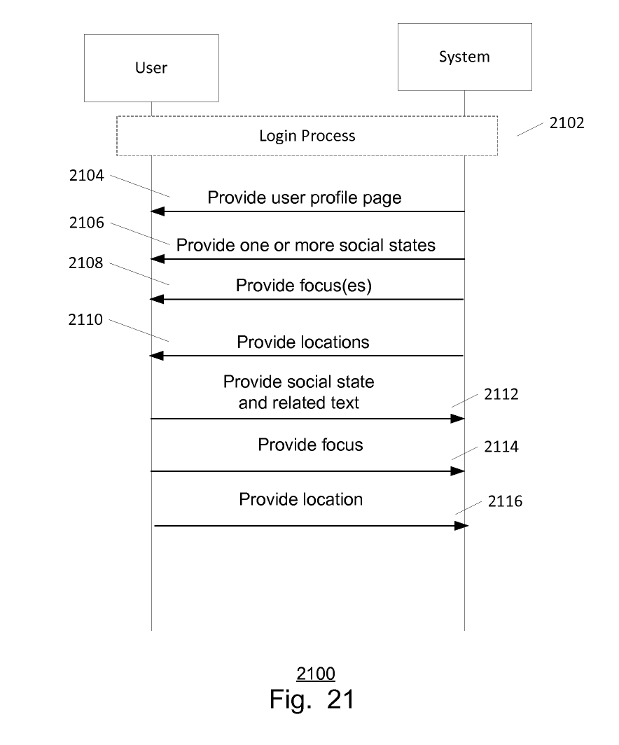

In one exemplary embodiment, a user may post or update any of a social state, a location, a focus or interest. FIG. 21 shows a data flow diagram of an example data flow represented by method 2100 by the social status interaction system 108 and a user device, in accordance with some example embodiments of the present invention. At 2102, a login process may be performed in response to, for example, the user navigating to a page related to the system. Subsequently, at 2104, the system may provide a user profile page. Additionally or alternatively, the system, as shown at 2106, may provide one or more “social states”, such as for example, Active, Exploring, Roaming, Building, Committed, Transporting, Activate, and Inactive. The system may additionally provide one or more focuses or interests, as shown at 2108. In some embodiments, the system may be configured to allow the user to select a particular number of focuses (e.g., three). In some embodiments, such focuses/interest may be provided via a free form text entry box corresponding to a tag cloud engine whereby interests are pre-programmed, learned via machine learning or added into the social status system to facilitate the matching of user states of mind and therefore funnel people into social activity with those of similar mindsets. The system may also be configured to provide one or more locations. In some embodiments, a menu may be provided, such that a city may be provided and hierarchically, the menu may provide to neighborhoods or other portions of the city.

At 2112, the user may provide via selection or input a social status and optionally, related text. At 2114, the user may provide via selection or via text input one or more focuses or interests. At 2116, the user may provide a location, via a menu as described above, text input, or selection on a map. Exemplary focuses or interests may include but are not limited to Live music, dance party, casual dining, casual upscale dining, fine dining, outdoor activities, indoor activities, Sporting events, Movies, Performing arts, outdoor seating, tailgating, karaoke, bars, sports bars, night clubs, hiking, playing sports, adventure, rock climbing, scuba diving, Casinos, boating, Arts and Crafts, Surfing, Skateboarding, Music Festival, Italian, American, Greek, Mexican, Tex-Mex, Vegetarian, Asian fusion, Chinese, Japanese, Thai, Vietnamese, Deli, Sandwich shop, Tappas, Pub Grill, Sushi, African, Pizza, Mediterranean, Middle eastern, Low country, soul food, seafood, Indian, Buffet, breakfast, Spanish, Latin, Brazilian Steakhouse, Steakhouse, Oyster Bar, Vegan, Organic, Raw. In some embodiments, such focuses or interests can be pre-programmed into a tag cloud engine corresponding to various selected tags for entities and various social interests. This tag cloud engine may be expanded by addition and subtraction of the various inclusions.

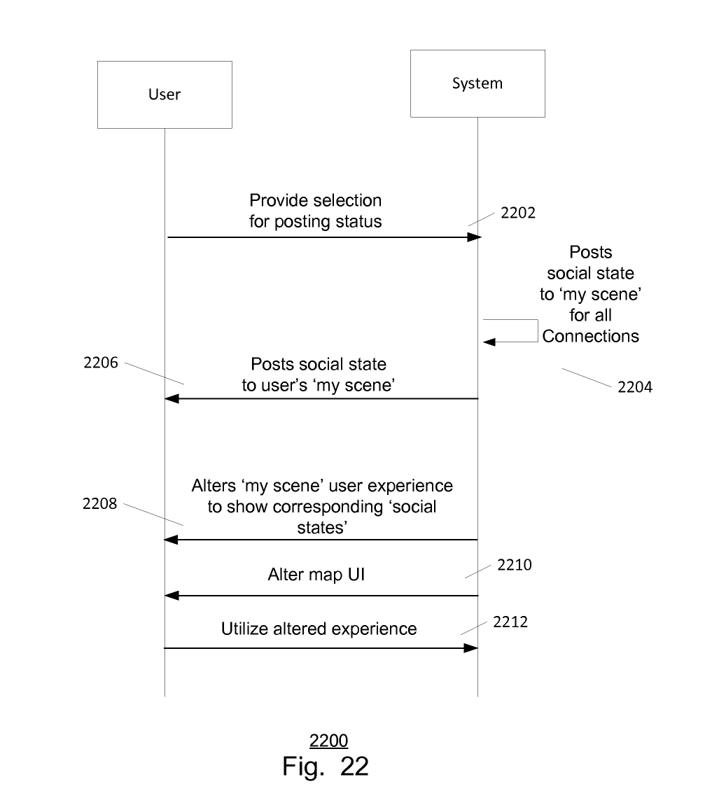

In one exemplary embodiment, after a user (e.g., a “socialtopian”) selects a status, location, focus or the like, the system may provide an experience for both the user and other users (e.g., community members) who have added this particular user to their “custom named connections groups”. Such a “my scene” news feed may have a customizable name. As such, FIG. 22 shows a data flow diagram of an example data flow represented by method 2200 by the social status interaction system 108 and a user's mobile device, in accordance with some example embodiments of the present invention. At 2202, a login or other authentication process may be performed and/or a selection may be provided indicating a status post or update. For example, the user may select a status or otherwise post a social state. At 2204, the system may post the user's social state to, for example, “My scene” news feed for all “Community members” who have this particular user in their custom named connections group. Furthermore, in some embodiments, as shown at 2206, the system may also post the social state on the user's own “my scene” as, for example, a social status post.

At 2208, the system may alter a ‘My Scene’ news feed user experience to show users with corresponding, location, “social states” and, in some embodiments, a interest/focus if selected, by other users (which have been added to the users custom named connection group) at the user's ‘My Scene’. In some embodiments, social states may include one of (1) building, where the system may present users that are “active” at the top of his/her feed; (2) roaming or active, where the system may present users with same state; (3) committed to a particular destination or event, where the system may present users with same commitment at the same time; and (4) inactive, where the system may, in some embodiments, present the user as inactive (e.g., the user is not being social at that time and wishes not to be contacted) or alternatively, in some embodiments, not present the user in any way. At 2210, the system may provide an updated or new map or otherwise alter the map user experience to, for example, show users with corresponding, location, “social states” and, in some embodiments, an interest/focus if selected, by other users (which have been added to the users custom named connection group) at the user's ‘My Scene’. At 2212, the user may utilize the altered experience. For example, the user may utilize the altered map experience and/or the altered ‘My Scene’ news feed experience.

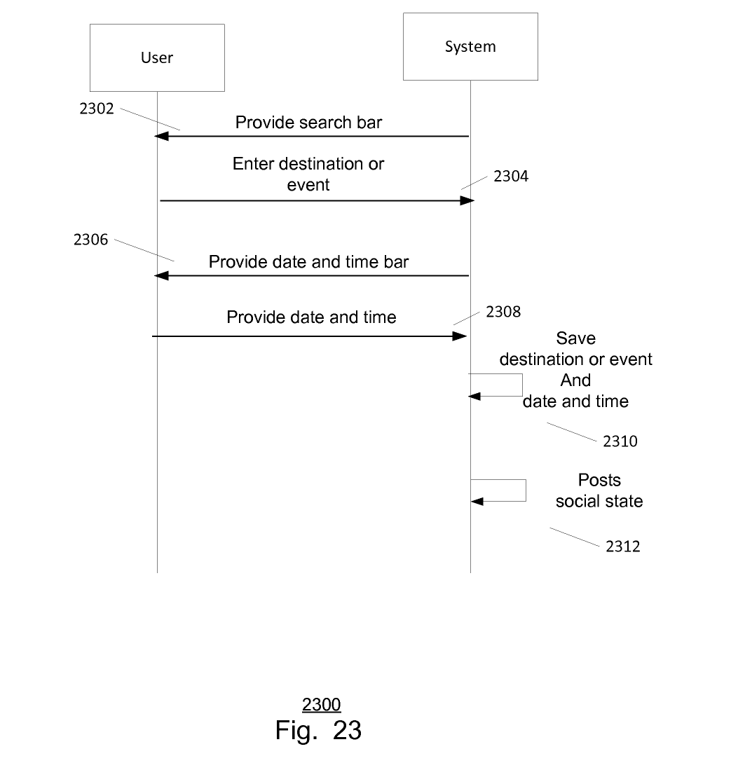

In one exemplary embodiment, a user may utilize the system to commit to an event or destination. As such, FIG. 23 shows a data flow diagram of an example data flow represented by method 2300 by the social status interaction system 108 and a user device, in accordance with some example embodiments of the present invention. At 2302, the system may provide a search bar. Subsequently, as shown at 2304, the user may enter or, in some embodiments, search for an event or destination to which to commit. Once selected, the system, at 2306, may provide a date and time bar. The user may then provide a date and time as shown at 2308. At 2310, the system may then save the selected event or destination and the selected date and time. Additionally or alternatively, the system, at 2312, may post the committal, as well as in some embodiments, the event or destination, a date and a time, and other related information.

In one exemplary embodiment, a user may use the system to configure a connection enabling a user, group, or entity to follow an entity, and/or enable a user to view another user, group, or entity's activity in the user's news feed (e.g. “my scene”). FIG. 24 shows a data flow diagram of an example data flow represented by method 2400 by the social status interaction system 108 and a user device, in accordance with some example embodiments of the present invention.

In some embodiments, a first user may send a community add request to a second user. As such, at 2402, the system may receive a notification that the first user added a second user. Such request may then trigger a notification to the second user to “add first user to my community” or “decline request”, as shown at 2404. If the second user selects “add to my community”, the system may receive a notification indicating the adding of the first user, as shown at 2406. The system may then provide a second question, such as “permit this user to view my social activity?”, as shown at 2410. Further, if the user selects “add to my community”, then the original requesting user receives a notification of such add, as shown at 2408. In this notification, the same second question may be asked to the first requesting user, but pertaining to the second user's ability to view the first's social activity, as shown at 2412. The system may receive a response from the second user at 2414, and from the first user at 2416. The system may then provide a ‘my scene’ new feed in accordance to the responses at 2418 and 2420, respectively.

A positive answer to the second question by either user results in the other user being able to “add user to my scene news feed”. For example, a positive answer by the first users enables the system to provide a ‘my scene news feed’ to the second user including the first user This ensures that a particular user news feed contains only other users that have permitted the particular user to view their social activity, and that this user desires to see such social activity. If a request receiving user responds positive to “add (request sending) user to my community” but negative to the second question pertaining to social activity, then the requesting user is added to the receiving users “community” but the request sending user does not have the option to add the receiving user to their news feed. Once this community add request process is completed with an answer from both users as to whether the other can view their social activity, the system may provide each user the ability to add the other user to “my scene news feed” via a list of users with such a management option. Thus, a user may be in second user's “community”, but not be able to view the second user's social activity. The ‘add to “my scene news feed” list’ is a separate list of users from the community and the name of which may be customized by the user. (e.g., My Best Friends, My Crew, The Amigos). This list is herein referred to as the “custom named connections group”. If “decline request” is selected at 2404, then there is no second question, as no community add took place. In summary, in some embodiments, in order to have access to another user's social activity, a user must accept or have a community request accepted, and then be granted a positive answer to a second question permitting viewing of social activity of the other user, and finally add that second user to their my scene news feed “custom named connections group”. If a user accepts a community request from a second user, but does not add (or is not permitted to add) the other user to their “custom named connections group”, then the second user is still in the user's community, and the user can communicate with the second user via chat, invitations, and the like, but the user may not view the social activity of the second user in their my scene news feed.

FIGS. 2-4, 6-13, and 16-18 illustrate example flowcharts of the operations performed by an apparatus, such as computing system 500 of FIG. 5, in accordance with example embodiments of the present invention. It will be understood that each block of the flowcharts, and combinations of blocks in the flowcharts, may be implemented by various means, such as hardware, firmware, one or more processors, circuitry and/or other devices associated with execution of software including one or more computer program instructions. For example, one or more of the procedures described above may be embodied by computer program instructions. In this regard, the computer program instructions which embody the procedures described above may be stored by a memory 501 of an apparatus employing an embodiment of the present invention and executed by a processor 503 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowcharts' block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts' block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts' block(s). As such, the operations of FIGS. 2-4, 6-13, and 16-18, when executed, convert a computer or processing circuitry into a particular machine configured to perform an example embodiment of the present invention. Accordingly, the operations of FIGS. 2-4 and 6-13 define an algorithm for configuring a computer or processor, to perform an example embodiment. In some cases, a general purpose computer may be provided with an instance of the processor which performs the algorithm of FIGS. 2-4, 6-13, and 16-18 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some example embodiments, certain ones of the operations herein may be modified or further amplified as described herein. Moreover, in some embodiments additional optional operations may also be included. It should be appreciated that each of the modifications, optional additions or amplifications described herein may be included with the operations herein either alone or in combination with any others among the features described herein.

Alternatively or additionally, the methods, apparatus and computer program products may be applied to other domains, for example manufacturing, sales, travel and/or the like. For example, a buyer may be interested in the purchase of a particular item. As such, the buyer may set his/her state to active and may select his/her interest to the particular item. In response, others users, groups or entities can view this state and can provide prices and other information to allow the user to make an offer to purchase the item. The buyer may then commit to purchase the item and activation may occur when the purchase is completed. In some embodiments, such activity would not necessarily be an “activation”. In some embodiments, such activity would provide the buyer with a status boost.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
providing a user interface configured to allow selection of at least one time or time period from a plurality of times;
receiving, via the user interface, user input that indicates at least one time or time period, a status, and a location of a user; and
determining one or more users or one or more entities that match at least the time or time period, the status, and the location of the user,
wherein the one or more users or the one or more entities that match at least the time or time period, the status, and the location of the user are provided with access to information related to the user and the user is provided with access to information related to the one or more users or the one or more entities.

2. The method according to claim 1, further comprising:
receiving user input indicating at least one interest of the user;
determining one or more entities that match at least the time or time period, the status, the location, and the interest of the user,
wherein the one or more entities that match the time or time period, the status, the location, and the interest of the user are provided with access to information related to the user or the user is provided with access to information related to the one or more entities.

3. The method according to claim 1, further comprising:
facilitating the one or more entities to provide one or more offers to the user based on one of the status and location of the user.

4. The method according to claim 2, further comprising:
facilitating the one or more entities to provide one or more offers to the user based on one of the status, location, and interest of the user.

5. The method according to claim 2, further comprising:
causing the user interface to be adapted to display one or more users or one or more entities that match at least one of the time or time period, the status, and the location of the user.

6. The method according to claim 5,
wherein the user interface is a map, and the map is adapted to display the one or more users or one or more entities that match at least one of the time or timer period, the status, and the location of the user.

7. The method according to claim 5,
wherein the user interface comprises at least a list, the list adapted to display the one or more users or one or more entities that match at least one of the time or timer period, the status, and the location of the user,
wherein an order of display of the one or more users or one or more entities is determined by relevance and a user credibility rating of the user.

8. The method according to claim 1, further comprising:
determining that the user and at least one or more users have a matching time or time period, status and location; and
facilitating formation of a group, the group comprised of the user and the one or more users.

9. The method according to claim 8, further comprising:
determining one or more entities that match the status and location of the group; and
enabling the one or more entities to interact with the group.

10. The method according to claim 1, wherein the user is a group of users.

11. The method according to claim 1, wherein a default time or time period is a current time, and one or more users or one or more entities that match at least the status and the location of the user at the current time is determined.

12. The method according to claim 1, wherein the status, location, or interest comprises additional text.

13. A method comprising:
providing input indicating at least one time or time period, a status, a location, and an interest; and
receiving data, configured for display on a news feed, indicative of one or more users or one or more entities that match the time or time period, the status and the location, an order of display of the one or more users or one or more entities determined by relevance to the interest.

14. The method according to claim 13, further comprising:
receiving one or more offers from the one or more entities based on one of the status, location, and interest of the user.

15. The method according to claim 14, further comprising:
providing an indication of an acceptance of the offer.

16. The method according to claim 13, further comprising:
selecting one or more users or one or more entities with which to communicate; and
communicating with one or more users or one or more entities that match the time or time period, the status, the location, and the interest of the user.

17. The method according to claim 14, further comprising:
in an instance in which the status or the interest is associated with an event, following the event or providing information indicating an intent to attend the event.

18. The method according to claim 13, wherein a default time or time period is a current time, and data indicative of one or more users or one or more entities that match at least the status and the location of the user at the current time is received.

19. A method comprising:
providing at least a time or time period and status information indicative of an event;
receiving data indicative of one or more users that match the status and the time or time period;
establishing a communication directed to the one or more users, wherein the communication comprises information related to the event.

20. The method according to claim 19, further comprising:
generating an offer related to the event; and
communicating the communication to the one or more users, the communication comprising the offer.

21. The method according to claim 20, further comprising:
selecting one or more users that match the status,
wherein the communication is communicated to the selected one or more users.

22. The method according to claim 19, wherein the user is a single user or a group of users.

23. The method according to claim 19, wherein a default time or time period is a current time, and data indicative of one or more users or one or more entities that match at least the status and the location of the user at the current time is received.

24. An apparatus comprising at least one processor and at least one memory including computer program code, the at least one memory and the computer program code configured to, with the processor, cause the apparatus to at least:
provide a user interface configured to allow selection of at least one time or time period from a plurality of times;
receive, via the user interface, user input that indicates at least one time or time period, a status, and a location of a user; and
determine one or more users or one or more entities that match at least the time or time period, the status, and the location of the user,
wherein the one or more users or the one or more entities that match at least the time or time period, the status, and the location of the user are provided with access to information related to the user and the user is provided with access to information related to the one or more users or the one or more entities.

25. The apparatus according to claim 24, wherein the at least one memory and the computer program code are further configured to, with the processor, cause the apparatus to:
receive user input indicating at least one interest of the user;
determine one or more entities that match at least the time or time period, the status, the location, and the interest of the user,
wherein the one or more entities that match the time or time period, the status, the location, and the interest of the user are provided with access to information related to the user or the user is provided with access to information related to the one or more entities.

26. The apparatus according to claim 24, wherein the at least one memory and the computer program code are further configured to, with the processor, cause the apparatus to:
facilitate the one or more entities to provide one or more offers to the user based on one of the status and location of the user.

27. The apparatus according to claim 26, wherein the at least one memory and the computer program code are further configured to, with the processor, cause the apparatus to:
facilitate the one or more entities to provide one or more offers to the user based on one of the status, location, and interest of the user.

28. The apparatus according to claim 25, wherein the at least one memory and the computer program code are further configured to, with the processor, cause the apparatus to:
cause the user interface to be adapted to display one or more users or one or more entities that match at least one of the time or time period, the status, and the location of the user.

29. The apparatus according to claim 28,
wherein the user interface is a map, and the map is adapted to display the one or more users or one or more entities that match at least one of the time or timer period, the status, and the location of the user.

30. The apparatus according to claim 28,
wherein the user interface comprises at least a list, the list adapted to display the one or more users or one or more entities that match at least one of the time or timer period, the status, and the location of the user,
wherein an order of display of the one or more users or one or more entities is determined by relevance and a user credibility rating of the user.

31. The apparatus according to claim 24, wherein the at least one memory and the computer program code are further configured to, with the processor, cause the apparatus to:
determine that the user and at least one or more users have a matching time or time period, status and location; and
facilitate formation of a group, the group comprised of the user and the one or more users.

32. The apparatus according to claim 31, wherein the at least one memory and the computer program code are further configured to, with the processor, cause the apparatus to:
determine one or more entities that match the status and location of the group; and
enable the one or more entities to interact with the group.

33. The apparatus according to claim 24, wherein the user is a group of users.

34. The apparatus according to claim 24, wherein a default time or time period is a current time, and one or more users or one or more entities that match at least the status and the location of the user at the current time is determined.

35. The apparatus according to claim 24, wherein the status, location, or interest comprises additional text.

36. An apparatus comprising at least one processor and at least one memory including computer program code, the at least one memory and the computer program code configured to, with the processor, cause the apparatus to at least:
provide input indicating at least one time or time period, a status, a location, and an interest; and
receive data, configured for display on a news feed, indicative of one or more users or one or more entities that match the time or time period, the status and the location, an order of display of the one or more users or one or more entities determined by relevance to the interest.

37. The apparatus according to claim 36, wherein the at least one memory and the computer program code are further configured to, with the processor, cause the apparatus to:
receive one or more offers from the one or more entities based on one of the status, location, and interest of the user.

38. The apparatus according to claim 37, wherein the at least one memory and the computer program code are further configured to, with the processor, cause the apparatus to:
provide an indication of an acceptance of the offer.

39. The apparatus according to claim 36, wherein the at least one memory and the computer program code are further configured to, with the processor, cause the apparatus to:
select one or more users or one or more entities with which to communicate; and
communicate with one or more users or one or more entities that match the time or time period, the status, the location, and the interest of the user.

40. The apparatus according to claim 37, wherein the at least one memory and the computer program code are further configured to, with the processor, cause the apparatus to:
in an instance in which the status or the interest is associated with an event, follow the event or providing information indicating an intent to attend the event.

41. The apparatus according to claim 36, wherein a default time or time period is a current time, and data indicative of one or more users or one or more entities that match at least the status and the location of the user at the current time is received.

42. An apparatus comprising at least one processor and at least one memory including computer program code, the at least one memory and the computer program code configured to, with the processor, cause the apparatus to at least:
provide at least a time or time period and status information indicative of an event;
receive data indicative of one or more users that match the status and the time or time period;
establish a communication directed to the one or more users, wherein the communication comprises information related to the event.

43. The apparatus according to claim 42, wherein the at least one memory and the computer program code are further configured to, with the processor, cause the apparatus to:
generate an offer related to the event; and
communicate the communication to the one or more users, the communication comprising the offer.

44. The apparatus according to claim 43, wherein the at least one memory and the computer program code are further configured to, with the processor, cause the apparatus to:
select one or more users that match the status,
wherein the communication is communicated to the selected one or more users.

45. The apparatus according to claim 43, wherein the user is a single user or a group of users.

46. The apparatus according to claim 43, wherein a default time or time period is a current time, and data indicative of one or more users or one or more entities that match at least the status and the location of the user at the current time is received.

47. A computer program product comprising at least one computer-readable storage medium having computer-executable program code instructions stored therein, the computer-executable program code instructions comprising program code instructions for:
providing a user interface configured to allow selection of at least one time or time period from a plurality of times;
receiving, via the user interface, user input that indicates at least one time or time period, a status, and a location of a user; and
determining one or more users or one or more entities that match at least the time or time period, the status, and the location of the user,
wherein the one or more users or the one or more entities that match at least the time or time period, the status, and the location of the user are provided with access to information related to the user and the user is provided with access to information related to the one or more users or the one or more entities.

48. The computer program product according to claim 47, wherein the computer-executable program code instructions further comprise program code instructions for:
receiving user input indicating at least one interest of the user;
determining one or more entities that match at least the time or time period, the status, the location, and the interest of the user,
wherein the one or more entities that match the time or time period, the status, the location, and the interest of the user are provided with access to information related to the user or the user is provided with access to information related to the one or more entities.

49. The computer program product according to claim 47, wherein the computer-executable program code instructions further comprise program code instructions for:
facilitating the one or more entities to provide one or more offers to the user based on one of the status and location of the user.

50. The computer program product according to claim 48, wherein the computer-executable program code instructions further comprise program code instructions for:
facilitating the one or more entities to provide one or more offers to the user based on one of the status, location, and interest of the user.

51. The computer program product according to claim 48, wherein the computer-executable program code instructions further comprise program code instructions for:
causing the user interface to be adapted to display one or more users or one or more entities that match at least one of the time or time period, the status, and the location of the user.

52. The computer program product according to claim 51,
wherein the user interface is a map, and the map is adapted to display the one or more users or one or more entities that match at least one of the time or timer period, the status, and the location of the user.

53. The computer program product according to claim 51,
wherein the user interface comprises at least a list, the list adapted to display the one or more users or one or more entities that match at least one of the time or timer period, the status, and the location of the user,
wherein an order of display of the one or more users or one or more entities is determined by relevance and a user credibility rating of the user.

54. The computer program product according to claim 47, wherein the computer-executable program code instructions further comprise program code instructions for:
determining that the user and at least one or more users have a matching time or time period, status and location; and
facilitating formation of a group, the group comprised of the user and the one or more users.

55. The computer program product according to claim 54, wherein the computer-executable program code instructions further comprise program code instructions for:
determining one or more entities that match the status and location of the group; and
enabling the one or more entities to interact with the group.

56. The computer program product according to claim 47, wherein the user is a group of users.

57. The computer program product according to claim 47, wherein a default time or time period is a current time, and one or more users or one or more entities that match at least the status and the location of the user at the current time is determined.

58. The computer program product according to claim 47, wherein the status, location, or interest comprises additional text.

59. A computer program product comprising at least one computer-readable storage medium having computer-executable program code instructions stored therein, the computer-executable program code instructions comprising program code instructions for:
providing input indicating at least one time or time period, a status, a location, and an interest; and
receiving data, configured for display on a news feed, indicative of one or more users or one or more entities that match the time or time period, the status and the location, an order of display of the one or more users or one or more entities determined by relevance to the interest.

60. The computer program product according to claim 59, wherein the computer-executable program code instructions further comprise program code instructions for:
receiving one or more offers from the one or more entities based on one of the status, location, and interest of the user.

61. The computer program product according to claim 60, wherein the computer-executable program code instructions further comprise program code instructions for:
providing an indication of an acceptance of the offer.

62. The computer program product according to claim 59, wherein the computer-executable program code instructions further comprise program code instructions for:
selecting one or more users or one or more entities with which to communicate; and
communicating with one or more users or one or more entities that match the time or time period, the status, the location, and the interest of the user.

63. The computer program product according to claim 60, wherein the computer-executable program code instructions further comprise program code instructions for:
in an instance in which the status or the interest is associated with an event, following the event or providing information indicating an intent to attend the event.

64. The computer program product according to claim 59, wherein a default time or time period is a current time, and data indicative of one or more users or one or more entities that match at least the status and the location of the user at the current time is received.

65. A computer program product comprising at least one computer-readable storage medium having computer-executable program code instructions stored therein, the computer-executable program code instructions comprising program code instructions for:
providing at least a time or time period and status information indicative of an event;
receiving data indicative of one or more users that match the status and the time or time period;
establishing a communication directed to the one or more users, wherein the communication comprises information related to the event.

66. The computer program product according to claim 65, wherein the computer-executable program code instructions further comprise program code instructions for:
generating an offer related to the event; and
communicating the communication to the one or more users, the communication comprising the offer.

67. The computer program product according to claim 66, wherein the computer-executable program code instructions further comprise program code instructions for:
selecting one or more users that match the status,
wherein the communication is communicated to the selected one or more users.

68. The computer program product according to claim 65, wherein the user is a single user or a group of users.

69. The computer program product according to claim 65, wherein a default time or time period is a current time, and data indicative of one or more users or one or more entities that match at least the status and the location of the user at the current time is received.
